(19) United States
(12) Patent Application Publication
(10) Pub. No.: US 2026/0341554 A1
(43) Pub. Date: Oct. 29, 2026

(54) APPARATUS FOR MANUFACTURING WIRE HARNESS AND METHOD FOR MANUFACTURING WIRE HARNESS

(71) Applicant: YAZAKI CORPORATION, Tokyo (JP)

(72) Inventors: Hiroyasu KOBAYASHI, Makinohara-shi, Shizuoka (JP); Jun YAGI, Makinohara-shi, Shizuoka (JP); Takahito SAITOU, Makinohara-shi, Shizuoka (JP)

(73) Assignee: YAZAKI CORPORATION, Tokyo (JP)

(21) Appl. No.: 19/108,222

(22) PCT Filed: Dec. 18, 2023
(86) PCT No.: PCT/JP2023/045188

§ 371 Date: Mar. 3, 2025

(30) Foreign Application Priority Data
Jan. 20, 2023 (JP) 2023-007352

(51) Int. Cl. H01B 13/012

(52) U.S. Cl. CPC H01B 13/01236; H01B 13/01281

(57) ABSTRACT

An apparatus for manufacturing wire harness (1) including a plurality of sliding portions (12); a tip-end connector connection portion connecting the electric wires (W18) to a tip-end connector mounted in the sliding portion (12); a small-scale gathering portion of a moving tape winding mechanism (22) and a large-scale gathering portion (electric-wire gathering portion) configured to selectively gather the electric wires (W18) that are pulled out to form a branch shape; rear-end connector movement portions of rear-end connector supply portion (16) provided to have rear-end connectors being mounted therein respectively, each rear-end connector movement portion is configured to sort the electric wires (W18) to each rear-end connector by each rear-end connector movement portion moving in an orthogonal direction (D13); and a rear-end connector connection portion of a connector connection portion (17) configured to cut the electric wire (W18) while connecting the electric wire to the rear-end connector.

### TECHNICAL FIELD

The present invention relates to an apparatus for manufacturing wire harness and a method for manufacturing wire harness for manufacturing a wire harness with a branch shape.

### BACKGROUND ART

Conventionally, as a manufacturing apparatus for manufacturing a wire harness with a branch shape, an apparatus in which a plurality of retention members for retaining wire harnesses are set to be arranged on a wiring board with a flat shape in accordance with the branch shapes is used (For example, see Patent Document 1). According to such a manufacturing apparatus, the wire harnesses are manufactured by a series of operations such as routing electric wires on the wiring board to form the branch shape and then performing tape winding at each location to determine the branch shape.

### CITATION LIST

### Patent Documents

[Patent Document 1] JP 2018-60643A

### SUMMARY OF THE INVENTION

### Technical Problem

Here, most of the operations using the above-mentioned manufacturing apparatus are performed manually by an operator. In particular, the operations from forming a branch shape to determine the shape by bundling are often performed by skilled operators based on experience. On the other hand, regarding the manufacturing of wire harnesses, the development of the apparatus to automatically perform the manufacturing operations without any human intervention is in progress. However, it is difficult to automate the operations from forming the branch shape to determine the shape by the skilled operators, and there is a need for such an apparatus that can perform these operations automatically.

Accordingly, the present invention is made focusing on the above-described technical problem, and an object of the present invention is to provide an apparatus for manufacturing a wire harness and a method for manufacturing a wire harness that can automatically perform the series of operations regarding the manufacturing of the wire harness.

### Solution to Problem

In order to solve the above-mentioned technical problem, an apparatus for manufacturing wire harness is characterized by including a plurality of sliding portions provided between a first end side and a second end side so as to move parallelly with each other in a straight line, the sliding portions being able to be mounted with tip-end connectors respectively; a tip-end connector connection portion provided at the first end side and configured to connector the electric wires, that are sorted to be provided to each sliding portion and are able to be pulled out from the first end side to the second end side, to the tip-end connector mounted in the sliding portion as a sorting destination; an electric-wire gathering portion configured to selectively gather the electric wires that are pulled out by movement of different sliding portions to form a branch shape; a tape winding portion configured to perform tape winding with respect to the gathered electric wires to determine the branch shape; a plurality of rear-end connector movement portions provided to have rear-end connectors being mounted therein respectively, each rear-end connector movement portion is configured to sort the electric wires being pulled out by the movement of the sliding portions to each rear-end connector by each rear-end connector movement portion moving in an orthogonal direction with respect to the movement direction of the sliding portion at the first end side; and a rear-end connector connection portion configured to cut the electric wire being sorted to each rear-end connector while connecting the electric wire to the rear-end connector.

Also, in order to solve the above-mentioned technical problem, a method for manufacturing wire harness is characterized by including a preceding connection step of sorting and connecting electric wires that are able to be pulled out to tip-end connectors provided in a plural respectively; an electric-wire pulling out step of moving the tip-end connectors along a straight line to be parallel to each other to pull out the electric wires; a tape winding step of selectively gathering the electric wires being pulled out to form a branch shape while determining the branch shape by performing tape winding; and a following connection step of sorting the electric wires being pulled out to rear-end connectors provided in a plural respectively, then cutting the electric wire being sorted to each rear-end connector while connecting the electric wire to the rear-end connector.

### Effect of the Invention

According to the above-described apparatus for manufacturing wire harness and the method for manufacturing wire harness, it is possible to automatically perform the series of operations regarding the manufacturing of the wire harness.

### BRIEF DESCRIPTION OF THE DRAWINGS

FIG. 1 is an exterior perspective view showing an apparatus for manufacturing wire harness according to an embodiment.

FIG. 2 is a block diagram showing the apparatus for manufacturing wire harness in FIG. 1 in schematical blocks.

FIG. 3 is a schematic view showing an example of the wire harness that is manufactured by the apparatus for manufacturing wire harness shown in FIG. 1 and FIG. 2.

FIG. 4 is a perspective view showing sliding portions and rails shown in FIG. 1 and FIG. 2.

FIG. 5 is a perspective view showing one of the sliding portions shown in FIG. 4 in an enlarged manner.

FIG. 6 is a perspective view showing tip-end connector supply portions as shown in FIG. 1 and FIG. 2, together with a situation in which tip-end connectors are supplied to tip-end connector mounting portions by these tip-end connector supply portions.

FIG. 7 is a perspective view showing the tip-end connector mounting portions as shown in FIG. 1 and FIG. 2, together with a situation in which the tip-end connectors are mounted on the sliding portions by these tip-end connector mounting portions.

FIG. 8 is a view showing portions where the electric wires are connected to the tip-end connectors in connector connection portions as shown in FIG. 1 and FIG. 2, together with the flow of the electric wire connection.

FIG. 9 is a view showing rear-end connector supply portions as shown in FIG. 1 and FIG. 2, together with the flow of the connector supply.

FIG. 10 is a view showing portions to connect the electric wires to the rear-end connectors in the connector connection portions as shown in FIG. 1 and FIG. 2, together with an initial operation in the flow of the electric wire connection.

FIG. 11 is a view showing a connection operation of the electric wires that is continuously performed to the initial operation shown in FIG. 10, in the connector connection portions.

FIG. 12 is a perspective view showing a fixed tape-winding mechanism as shown in FIG. 1 and FIG. 2.

FIG. 13 is a planar view showing an under-pulling tape winding portion provided in the fixed tape-winding mechanism as shown in FIG. 12 when viewed from a direction of arrow V11 in FIG. 12.

FIG. 14 is a perspective view showing an electric wire grasping/additional-length applying portion as shown in FIG. 1 and FIG. 2.

FIG. 15 is a perspective view showing a situation in which an additional length of the electric wire is pulled out by the electric-wire grasping mechanism corresponding to the additional-length applying as shown in FIG. 14.

FIG. 16 is a schematic planar view showing a situation in which the additional length of the electric wire is pulled out by the electric wire grasping mechanism shown in FIG. 15.

FIG. 17 is a view showing a modification of the electric-wire grasping mechanism as shown in FIG. 16 in a similar schematic planar view to FIG. 16.

FIG. 18 is a perspective view showing a large-scale gathering portion as shown in FIG. 1 and FIG. 2.

FIG. 19 is a perspective view showing a situation in which the large-scale gathering portion shown in FIG. 18 gathers the electric wires.

FIG. 20 is a perspective view showing a moving tape winding mechanism as shown in FIG. 1 and FIG. 2, together with a robot arm.

FIG. 21 is a perspective showing the moving tape winding mechanism shown in FIG. 20 as a single item.

FIG. 22 is a perspective view showing a clip attachment portion as shown in FIG. 1 and FIG. 2, together with the robot arm.

FIG. 23 is a perspective view showing an exterior material attachment portion as shown in FIG. 1 and FIG. 2, together with the robot arm.

FIG. 24 is a perspective view showing an existing-electric-wire arrangement portion as shown in FIG. 1 and FIG. 2, together with the robot arm.

FIG. 25 is a perspective view showing the existing-electric-wire arrangement portion shown in FIG. 24 as a single item.

FIG. 26 is a perspective view showing a dispensing portion as shown in FIG. 1 and FIG. 2, together with the robot arm.

FIG. 27 is a perspective view showing the dispensing portion as shown in FIG. 26 as a single item.

FIG. 28 is a schematic view showing Step S11 to Step S14 of a method for manufacturing wire harness to manufacture the wire harness as shown in FIG. 3 by the apparatus for manufacturing wire harness as shown in FIG. 1 and FIG. 2.

FIG. 29 is a schematic view showing Step S15 to Step S18 of the method for manufacturing wire harness to manufacture the wire harness as shown in FIG. 3 by the apparatus for manufacturing wire harness as shown in FIG. 1 and FIG. 2.

FIG. 30 is a schematic view showing Step S19 to Step S22 of the method for manufacturing wire harness to manufacture the wire harness as shown in FIG. 3 by the apparatus for manufacturing wire harness as shown in FIG. 1 and FIG. 2.

FIG. 31 is a schematic view showing Step S23 to Step S25 of the method for manufacturing wire harness to manufacture the wire harness as shown in FIG. 3 by the apparatus for manufacturing wire harness as shown in FIG. 1 and FIG. 2.

FIG. 32 is a schematic view showing Step S26 to Step S29 of the method for manufacturing wire harness to manufacture the wire harness as shown in FIG. 3 by the apparatus for manufacturing wire harness as shown in FIG. 1 and FIG. 2.

FIG. 33 is a schematic view showing Step S30 to Step S33 of the method for manufacturing wire harness to manufacture the wire harness as shown in FIG. 3 by the apparatus for manufacturing wire harness as shown in FIG. 1 and FIG. 2.

FIG. 34 is a schematic view showing Step S34 to Step S37 of the method for manufacturing wire harness to manufacture the wire harness as shown in FIG. 3 by the apparatus for manufacturing wire harness as shown in FIG. 1 and FIG. 2.

FIG. 35 is a schematic view showing Step S38 to Step S40 of the method for manufacturing wire harness to manufacture the wire harness as shown in FIG. 3 by the apparatus for manufacturing wire harness as shown in FIG. 1 and FIG. 2.

FIG. 36 is a schematic view showing Step S51 and Step S52 of a method for controlling tension of electric wire performed under the control of the control portion during the execution of the method for manufacturing wire harness as shown in FIG. 28 to FIG. 35.

FIG. 37 is a schematic view showing Step S53 to Step S55 of the method for controlling tension of electric wire performed under the control of the control portion during the execution of the method for manufacturing wire harness as shown in FIG. 28 to FIG. 35.

FIG. 38 is a schematic view showing Step S56 and Step S57 of the method for controlling tension of electric wire performed under the control of the control portion during the execution of the method for manufacturing wire harness as shown in FIG. 28 to FIG. 35.

### DESCRIPTION OF EMBODIMENTS

Hereinafter, an apparatus for manufacturing wire harness, a method for manufacturing wire harness, a wire harness, an apparatus for controlling tension, and a method for controlling tension will be described.

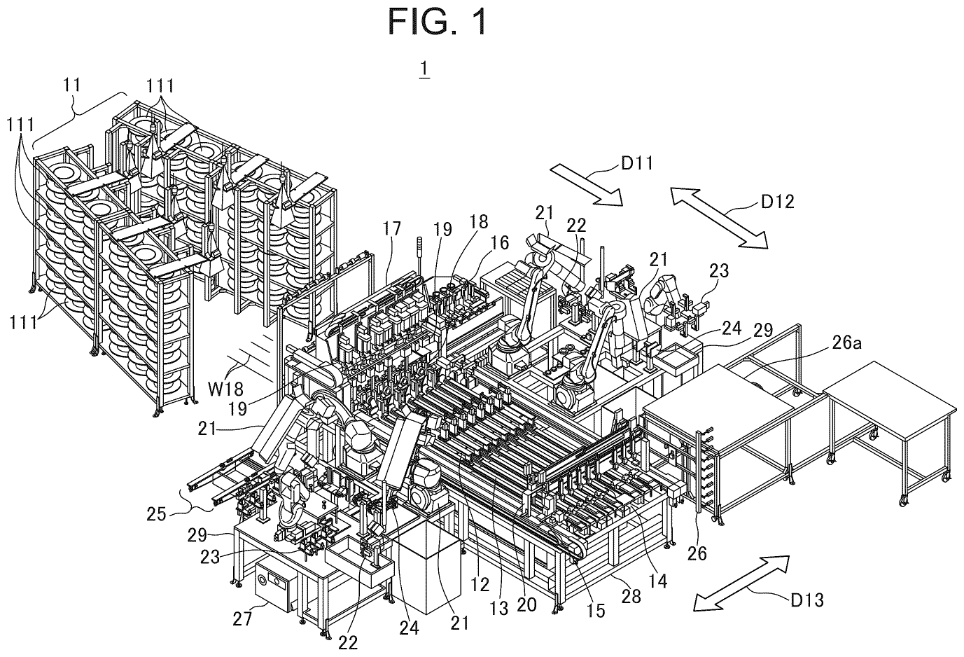

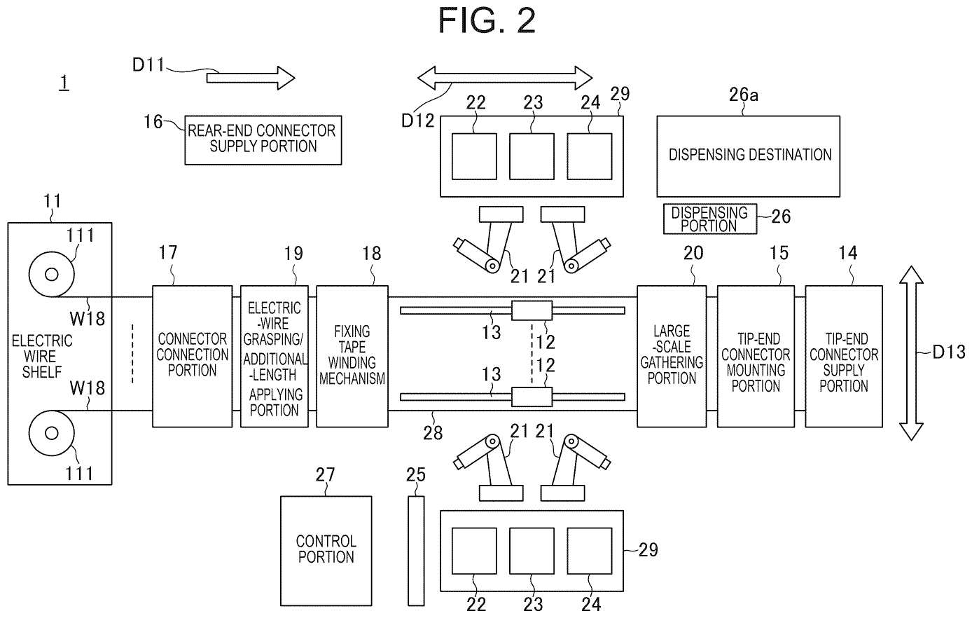

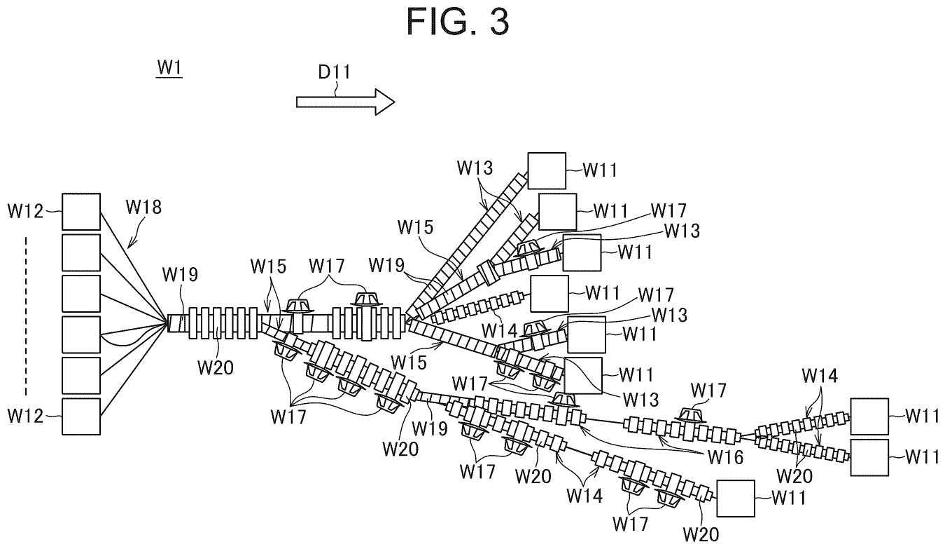

FIG. 1 is an exterior perspective view showing an apparatus for manufacturing wire harness according to an embodiment, FIG. 2 is a block diagram showing the apparatus for manufacturing wire harness in FIG. 1 in schematical blocks, and FIG. 3 is a schematic view showing an example of the wire harness that is manufactured by the apparatus for manufacturing wire harness shown in FIG. 1 and FIG. 2.

An apparatus for manufacturing wire harness 1 according to the present embodiment is an apparatus for automatically manufacturing a wire harness W1 with a branch shape shown as an example in FIG. 3.

The wire harness W1 as a manufacturing target is a member that is mounted and routed in a motor vehicle to connect a plurality of devices inside the vehicle. This wire harness W1 includes a plurality of tip-end connectors W11, a plurality of rear-end connectors W12, a branch-wire tape-winding portion W13, a branch-wire exterior material portion W14, a branch tape-winding portion W15, a branch exterior material portion W16, and a plurality of fixing clips W17.

The tip-end connectors W11 are connectors positioned at a tip-end side in a pulling-out direction D11 of the electric wires W18 in the apparatus for manufacturing wire harness 1. The tip-end side described above corresponds to the tip-end side of a branch in the wire harness W1. The rear-end connectors W12 are connectors positioned at a rear-end side in the pulling-out direction D11, and the described rear-end side corresponds to a root side of the branch in the wire harness W1. According to the present embodiment, the rear-end connectors W12 are less than the tip-end connectors W11, part of the electric wires W18 that are connected to the plurality of tip-end connectors W11 are bundled in several front-end connectors W11 to be connected to one rear-end connector W12. According to the present embodiment, either of the tip-end connectors W11 and the rear-end connectors W12 are insulation displacement connectors.

The branch-wire tape-winding portion W13 is a portion where among the plurality of prepared electric wires W18, the electric wires W18 connected to the same tip-end connector W11 are directly wound by tapes W19 to form a branch wire in the branch shape. The branch-wire exterior material portion W14 is a portion where an exterior material W20 such as a corrugated tube is directly attached to the electric wires W18 connected to the same tip-end connector W11 to form the branch wire similar to the branch-wire tape-winding portion W13. Also, regarding the branch wire portion where the exterior material W20 is attached to the tapes W19 that is wound around the electric wires W18, it is referred to as the branch-wire tape-winding portion W13 to be described.

The branch tape-winding portion W15 is a portion where the branch-wire tape-winding portions W13 in the electric wires W18 connected to different tip-end connectors W11 are further wound by tapes to form a branch. According to the present embodiment, as the branch tape-winding portion W15, a portion where two of branch-wire tape-winding portions W13 are wound by tapes and a portion where a further branch-wire tape-winding portion W13 is added thereto to be wound by tapes are shown as examples. The branch exterior material portion W16 is a portion where the branch-wire exterior material portions W14 in the electric wires W18 connected to different tip-end connectors W11 are bundled together, and the exterior material W20 is further attached thereto to form a branch.

Regarding the portion where the branch-wire exterior material portion W14 and the branch exterior material portion W16 are added to the branch-wire tape-winding portion W13 to be bundled together and wound by tapes, it is referred to as the branch tape-winding portion W15 and described. Also, according to the present embodiment, a location where the exterior material W20 is attached on the branch tape-winding portion W15 is also existing. Then, the branch tape-winding portion W15 becomes a portion being formed by overlapping and winding the tapes W19 to the tapes W19 in the branch-wire tape-winding portion W13.

The fixing clips W17 are fixing members for fixing this wire harness W1 to predetermined fixing destination, and the fixing clips W17 are attached to several locations of the wire harness W1.

The apparatus for manufacturing wire harness 1 as shown in FIG. 1 and FIG. 2 is an apparatus to automatically manufacture the above-described wire harness W1 with the branch shape. That is, the apparatus for manufacturing wire harness is the apparatus to automatically perform the series of processing including pulling out the electric wires W18, the connection of the tip-end connector W11 and the rear-end connector W12, the formation of the branch shape and the determination of the shape by winding tapes thereto, and the attachment of the exterior material W20 and the fixing clip W17.

The apparatus for manufacturing wire harness 1 includes an electric wire shelf 11, a sliding portion 12, a rail 13, a tip-end connector supply portion 14, a tip-end connector mounting portion 15, a rear-end connector supply portion 16, a connector connection portion 17, a fixed tape winding mechanism 18, and an electric-wire grasping/additional-length-applying portion 19. Also, the apparatus for manufacturing wire harness 1 also includes a large-scale gathering portion 20, a robot arm 21, a moving tape winding mechanism 22, a clip attachment portion 23, an exterior material attachment portion 24, an existing-electric-wire arrangement portion 25, a dispensing portion 26, and a control portion 27.

The electric wire shelf 11 is a structural object to accommodate a plurality of electric wire reels 111, and the plurality of electric wires W18 for manufacturing the wire harness W1 are pulled out from this electric wire shelf 11 in a pulling-out direction D11.

The sliding portion 12 is a portion being capable of being equipped with the tip-end connectors W11 to move in a straight line between a first end side as the electric wire shelf 11 side and a second end side as the front end side in the pulling-out direction D11. The rail 13 is a rail member retaining this sliding portion 12 in a movable manner in a movement direction D12 as a front-rear direction in the pulling-out direction D11. This movement of the sliding portion 12 along the rail 13 is performed by a servo motor.

According to the present embodiment, the sliding portions 12 in a state of being assembled in the rail 13 are provided and arranged in 9 columns in an orthogonal direction D13 with respect to the movement direction D12.

The tip-end connector supply portion 14 stocks the plurality of tip-end connectors W11 as a portion to supply the tip-end connectors W11 to the tip-end connector mounting portion 15. Then, the tip-end connector mounting portion 15 is a portion to mount the supplied tip-end connector W11 to the sliding portion 12. The supply of the tip-end connectors W11 and the mounting to the sliding portion 12 are performed at the above-described second end side in the movement route of the sliding portion 12. The sliding portion 12 carries the mounted tip-end connectors W11 to the connector connection portion 17 by moving to the first end side as the side of the electric wire shelf 11. When the electric wire W18 is connected to the tip-end connector W11 at this connector connection portion 17, at this time, the electric wire W18 is pulled out by the sliding portion 12 moving toward the second end side in the pulling-out direction D11.

The rear-end connector supply portion 16 is a portion being provided at a position offset to the connector connection portion 17 in the orthogonal direction D13 at the first end side as the side of the electric wire shelf 11, that is, at the pulling-out root side of the electric wire W18. The rear-end connector supply portion 16 stocks a plurality of rear-end connectors W12 at the above-described offset position while extracting the rear-end connectors W12 to supply toward the connector connection portion 17.

The connector connection portion 17 is provided at the pulling-out root side of the electric wires W18, and when the tip-end connectors W11 are carried by the sliding portion 12, the electric wires W18 are connected to this tip-end connector W11 by crimping the electric wires W18. Also, after pulling out the electric wires W18, when the rear-end connectors W12 are supplied by the rear-end connector supply portion 16, at an appropriate timing thereafter, the connector connection portion 17 cuts the electric wire W18 in the sate of being pulled out while connecting it to the rear-end connector W12.

The fixed tape winding mechanism 18 is a portion being fixedly provided at the pulling-out root side of the electric wires W18 to perform tape winding of the electric wires W18 being pulled out by the sliding portion 12.

The electric-wire grasping/additional-length-applying portion 19 is a portion grasping the plurality of electric wires W18 that are pulled out by the sliding portion 12 in a releasable manner while further pulling out the additional lengths of part of the electric wires W18, if necessary.

The large-scale gathering portion 20 is part of a mechanism configured to selectively gather the electric wires W18 that are pulled out by the movements of different sliding portions 12 to form the branch shape. This large-scale gathering portion 20 becomes a portion that in a case in which an amount of electric wires of the target electric wires W18 exceeds a predetermined amount, the large-scale gathering portion 20 gathers these electric wires W18 with the amount of electric wires.

According to the apparatus for manufacturing wire harness 1 of the present embodiment, the portions described so far are assembled in a metal frame 28 to be constructed as an integral structure. That is, the sliding portion 12, the rail 13, the tip-end connector supply portion 14, the tip-end connector mounting portion 15, the rear-end connector supply portion 16, the connector connection portion 17, the fixed tape winding mechanism 18, and the electric-wire grasping/additional-length applying portion 19 are assembled in the metal frame 28. Then, the electric wire shelf 11 is arranged at the first end side of this integral structure, and in the circumference of the integral structure, the robot arm 21, the moving tape winding mechanism 22, the clip attachment portion 23, the exterior material attachment portion 24, the existing-electric-wire arrangement portion 25, the dispensing portion 26, and the control portion 27 are arranged therein.

The robot arm 21 selects and grasps one mechanical apparatus among the multiple types of mechanical apparatus including the moving tape winding mechanism 22, the clip attachment portion 23, the exterior material attachment portion 24, and the dispensing portion 26 and then carries the mechanical apparatus to an operation position by this mechanical apparatus. The, the robot arm 21 becomes the portion to move the carried mechanical apparatus in response to the operational movement. According to the present embodiment, a total of 4 robot arms 21, with two on each side in the orthogonal direction D13 of the metal frame 28 to which the rail 13 and the like are assembled, are arranged.

The moving tape winding mechanism 22 is a mechanism configured to wind the tapes W19 to the winding target. Also, the clip attachment portion 23 is a mechanism configured to attach the fixing clips W17 to the electric wires W18 that are wound by the tapes and the electric wires W18 to which the exterior material W20 is attached on the tapes W19 and the exterior material W20. The exterior material attachment portion 24 is a mechanism configured to perform the attachment of the exterior material W20 such as the corrugated tubes or the like directly with respect to the electric wires W18 or the electric wires W18 that are wound by tapes on the tape W19.

The moving tape winding mechanism 22, the clip attachment portion 23, and the exterior attachment portion 24 are carried on the mechanism waiting tables 29 being arranged adjacent to the robot arms 21 wherein two robot arms 21 are disposed on both sides of the metal frame 28, respectively. The robot arm 21 selects and grasps the mechanical apparatus corresponding to the operation content on each mechanism waiting table 29, and then carries the mechanical apparatus to the operation position.

The existing-electric-wire arrangement portion 25 is a mechanism configured to arrange the existing electric wires, whose two ends are connected to the tip-end connector W11 and the rear-end connector W12 at an operation location being different from the apparatus for manufacturing wire harness 1, parallelly to the electric wires W18 that are pulled out by the movement of the sliding portion 12. This existing-electric-wire arrangement portion 25 is disposed at a side portion of one mechanism waiting table 29. The robot arm 21, when arranging the existing electric wires, selects and grasps the existing-electric-wire arrangement portion 25 at the side portion of this mechanism waiting table 29, and carries the existing-electric-wire arrangement portion 25 to the operation position.

The dispensing portion 26 is a mechanism configured to retain the completed wire harness W1 while removing the front-end connectors W11 and the rear-end connectors W12 from each retaining portion all at once, and move the wire harness W1 onto a table as a predetermined dispensing destination 26a. The table as the dispensing destination 26a is arranged to be adjacent to the mechanism waiting table 29 at one side being opposite to the other mechanism waiting table 29 where the existing-electric-wire arrangement portion 25 is arranged. Then, the dispensing portion 26 is arranged at the side portion of this dispensing destination 26a. The robot arm 21, when the wire harness W1 is finished, selects and grasps the dispensing portion 26 at the side portion of this dispensing destination 26a and then carries the dispensing portion 26 to the operation position.

The control portion 27 is a computer apparatus configured to control operations of each configuration element in the above-described apparatus for manufacturing wire harness 1, and is disposed to be adjacent to the mechanism waiting table 29 where the existing-electric-wire arrangement portion 25 is disposed. According to the present embodiment, the control portion 27 is equipped with a tablet terminal as an interface portion with an operator, and receives instructions to initiate operations from the operator via this tablet terminal.

Each configuration element in the apparatus for manufacturing wire harness 1 as briefly described above will be further described by referring to other figures.

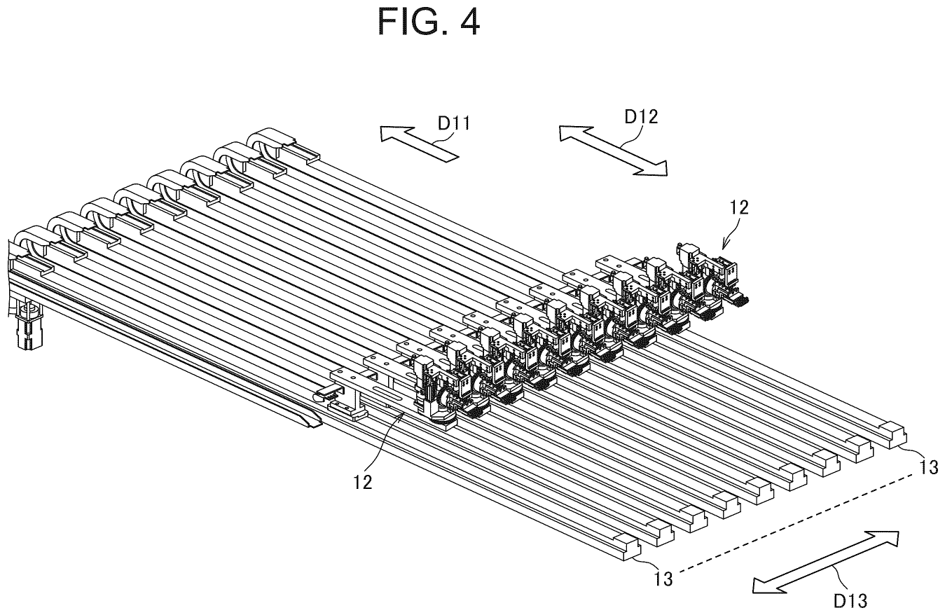

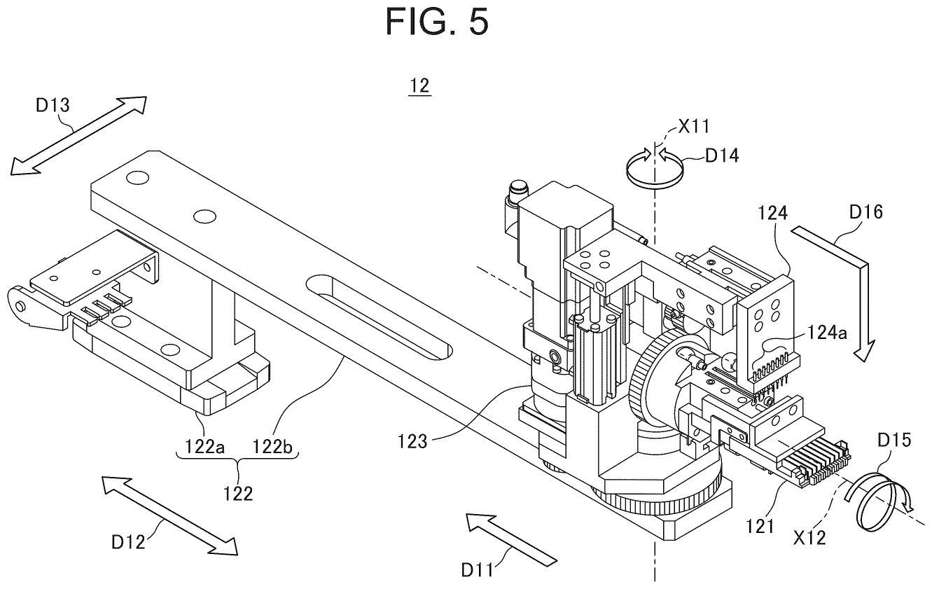

FIG. 4 is a perspective view showing sliding portions and rails shown in FIG. 1 and FIG. 2, and FIG. 5 is a perspective view showing one of the sliding portions shown in FIG. 4 in an enlarged manner. Also, in these FIG. 4 and FIG. 5, in order to make it easy to view the structure of the sliding portion, the sliding portion 12 and the rail 13 are shown in a posture where the pulling-out direction D11 of the electric wires W18 is opposite to that in FIG. 1 and FIG. 2.

According to the present embodiment, the 9 rails 13 are arranged to be parallel to each other in the orthogonal direction D13 with respect to the pulling-out direction D11, and for each rail 13, one sliding portion 12 is retained to be movable in the movement direction D12 as the front-rear direction of the pulling-out direction D11.

The sliding portion 12 is a portion configured to pull out the electric wires W18 connected to the tip-end connector W11 by moving in a straight line along the rail 13 while carrying the tip-end connector W11. This sliding portion 12 includes a retaining portion 121 for retaining the tip-end connector W11, a sliding main body portion 122 carrying this retaining portion 121, and a connection portion 123 mediating the carriage of the retaining portion 121 with respect to the sliding main body portion 122. Furthermore, the sliding portion 12 is provided with a conductivity inspection portion 124 performing the conductivity inspection to the tip-end connector W11 when manufacturing the wire harness W1.

At first, the sliding main body portion 122 is connected to the rail 13 to be movable in the movement direction D12. This sliding main body portion 122 includes a sliding connection portion 122a with respect to the rail 13, and an arm portion 122b extending in a belt-plate shape from this sliding connection portion 122a in an opposite direction with respect to the pulling-out direction D11 of the electric wire, wherein the connection portion 123 is connected to a tip-end portion thereof.

The connection portion 123 is a columnar portion to be attached to the tip-end portion of the arm portion 122b so as to be rotatable in a rotation direction D14 with a rotation axis X11 being orthogonal to both of movement direction D12 of the sliding portion 12 and the orthogonal direction D13 in the apparatus for manufacturing wire harness 1. When this connection portion 123 rotates in the rotation direction D14, the retaining portion 121 rotates in the rotation direction D14 such that the electric wires W18 from the tip-end connector W11 that are retained by the retaining portion 121 are directed to the desired direction around the rotation axis X11.

The retaining portion 121 is a columnar portion extending from an intermediate portion of the connection portion 123 in the opposite direction with respect to the pulling-out direction D11, and a tip-end portion thereof retains the tip-end connector W11. Also, the retaining portion 121 is attached so as to be rotatable in a twisting direction D15 with a twist axis X12 as a rotation center along the movement direction D12 of the sliding portion 12. By rotating the retaining portion 121 in the twisting direction D15 in a state of retaining the tip-end connector W11 after the electric wire connection, the electric wires W18 from the tip-end connector W11 can be twisted.

The conductivity inspection portion 124 is a portion with a rectangular plate shape that is attached to the connection portion 123 so as to advance in the opposite direction with respect to the pulling-out direction D11 above the retaining portion 121 to be movable in an inspection movement direction D16 of descending to the mounting position of the tip-end connector W11 in the retaining portion 121. At the lower end edge thereof, a plurality of inspection pins 124a are provided. As the conductivity inspection portion 124 moves in the inspection movement direction D16, the inspection pin 124a comes into contact with the conductive portion in the tip-end connector W11 such that the conductivity inspection is performed. The conductivity inspection at this time is performed under the control of the control portion 27.

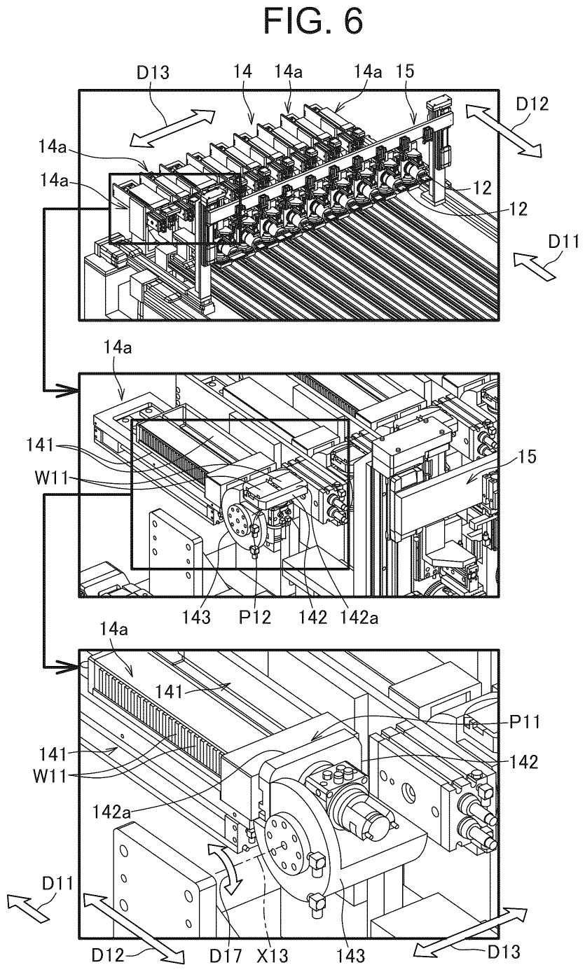

FIG. 6 is a perspective view showing the tip-end connector supply portions as shown in FIG. 1 and FIG. 2, together with a situation in which the tip-end connectors are supplied to tip-end connector mounting portions by these tip-end connector supply portions. Also, even in FIG. 6, similar to the above-described FIG. 4 and FIG. 5, the tip-end connector supply portion 14 and the tip-end connector mounting portion 15 are shown in the posture where the pulling-out direction D11 of the electric wires W18 are opposite to that in FIG. 1 and FIG. 2.

The tip-end connector supply portion 14 are the portions where 9 rows of tip-end supply mechanism 14a are arranged in the orthogonal direction D13 in the apparatus for manufacturing wire harness 1 so as to be in one-to-one correspondence with the 9 rows of sliding portions 12. Each tip-end supply mechanism 14a includes a tip-end stocker 141, a connector delivery portion 142, and a rotation mechanism 143.

In the tip-end stocker 141, the tip-end connectors W11 as the insulation displacement connectors in a rectangular plate shape are overlapped in a thickness direction along the movement direction D12 of the sliding portion 12 to be stocked in a plural. According to the present embodiment, inside each tip-end supply mechanism 14a, the tip-end stockers 141 are provided to be arranged in 2 rows in the orthogonal direction D13.

The connector delivery portion 142 is a portion in a rectangular plate shape having a connector mounting surface 142a to be able to mount 2 tip-end connectors W11. The connector delivery portion 142 catches the tip-end connector W11 being stocked in the tip-end stocker 141 at a catching posture P11 to direct this connector mounting surface 142a toward the tip-end stocker 141. Furthermore, the connector delivery portion 142 delivers the tip-end connector W11 to the tip-end connector mounting portion 15 at a delivery posture P12 to direct the connector mounting surface 142a upwards in a connector mounting state.

The rotation mechanism 143 is a mechanical portion configured to rotatably support the above-described connector delivery portion 142 in the delivery rotation direction D17, between the catching posture P11 and the delivery posture P12, with a rotation axis X13 along the orthogonal direction D13 as a center.

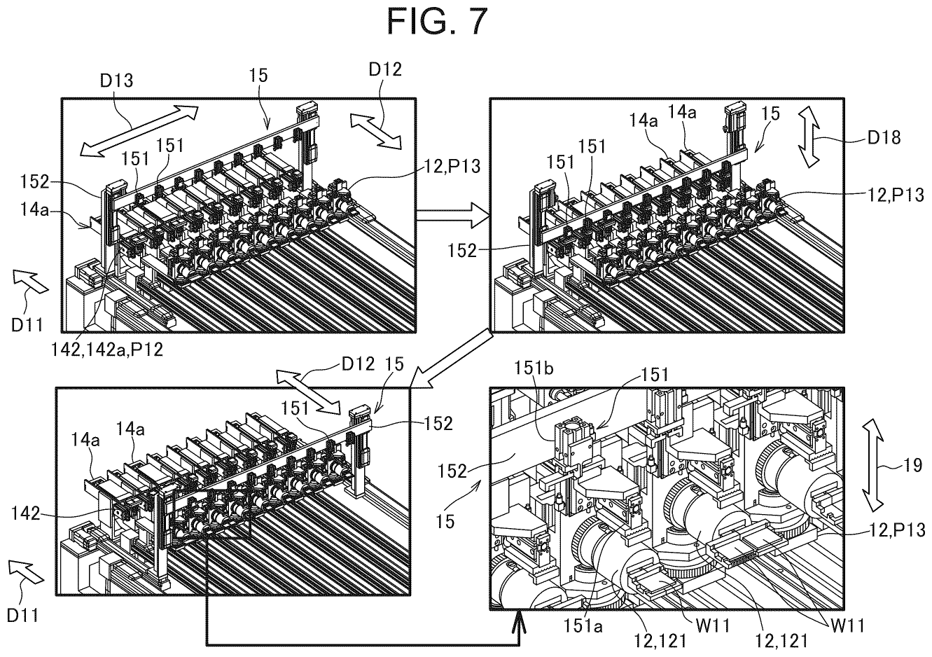

FIG. 7 is a perspective view showing the tip-end connector mounting portion as shown in FIG. 1 and FIG. 2 together with a situation in which the tip-end connectors are mounted to the sliding portions by the tip-end connector mounting portions. Also, even in FIG. 7, similar to the above-described FIG. 4 and FIG. 5, the tip-end connector supply portion 14 and the tip-end connector mounting portion 15 are shown in the posture where the pulling-out direction D11 of the electric wires W18 are opposite to that in FIG. 1 and FIG. 2.

The tip-end connector mounting portion 15, at first, includes 9 rows of connector transporting portions 151 in one-to-one correspondence with 9 rows of tip-end supply mechanism 14a and sliding portions 12. Furthermore, the tip-end connector mounting portion 15 includes a support bridge 152 configured to support these 9 rows of connector transporting portions 151 in a state of being arranged in the orthogonal direction D13 and move them in the movement direction D12.

Each connector transporting portion 151 includes a connector hand portion 151a and a hand up-down mechanism 151b. The connector hand portion 151a is a portion configured to take up the tip-end connectors W11 from the connector mounting surface 142a of the connector delivery portion 142 in the delivery posture P12 and then mount the tip-end connector W11 toward the retaining portion 121 of the sliding portion 12. Then, the hand up-down mechanism 151b is a mechanical portion configured to move the connector hand portion 151a in a receiving direction D18 of raising and lowering the connector hand portion 151a with respect to the connector mounting surface 142a and in a mounting direction D19 of raising and lowering the connector hand portion 151a with respect to the retaining portion 121 of the sliding portion 12.

According to the present embodiment, the tip-end connectors W11 that are delivered by the connector delivery portion 142 in each tip-end supply mechanism 14a of the tip-end connector supply portion 14 transported to the retaining portion 121 of the sliding portion 12 by each connector transporting portion 151 of the tip-end connector mounting portion 15. Due to the operations of each portion, the tip-end connectors W11 stocked in the tip-end stocker 141 are mounted in the retaining portion 121 of the sliding portion 12. The series of operations regarding mounting are performed at the second-end side being opposite to the first-end side as the side of the electric wire shelf 11 in the apparatus for manufacturing wire harness 1. Also, in the tip-end connectors W11 mounted in the sliding portion 12 at the second-end side, the electric wires W18 are in the unconnected state.

In this manner, according to the present embodiment, regarding the sliding portion 12, in the pulling-out direction D11 of the electric wires W18, the tip-end connectors W11 where the electric wires W18 are unconnected are mounted at the tip-end connector mounting position P13 at the second-end side being opposite to the pulling-out root side (the first-end side as the side of the electric wire shelf 11). Then, after the mounting, the sliding portion 12 moves toward the connector connection portion 17 at the pulling-out root side.

The connector connection portion 17 includes a portion of connecting the electric wire W18 to the tip-end connector W11 that is retained by the sliding portion 12, and a portion of connecting the electric wire W18, that is pulled out by the sliding portion 12 moving in the pulling-out direction D12 after the connection, to the rear-end connector W12. Hereafter, at first, the portion in the connector connection portion 17 of connecting the electric wire W18 to the tip-end connector W11 will be described.

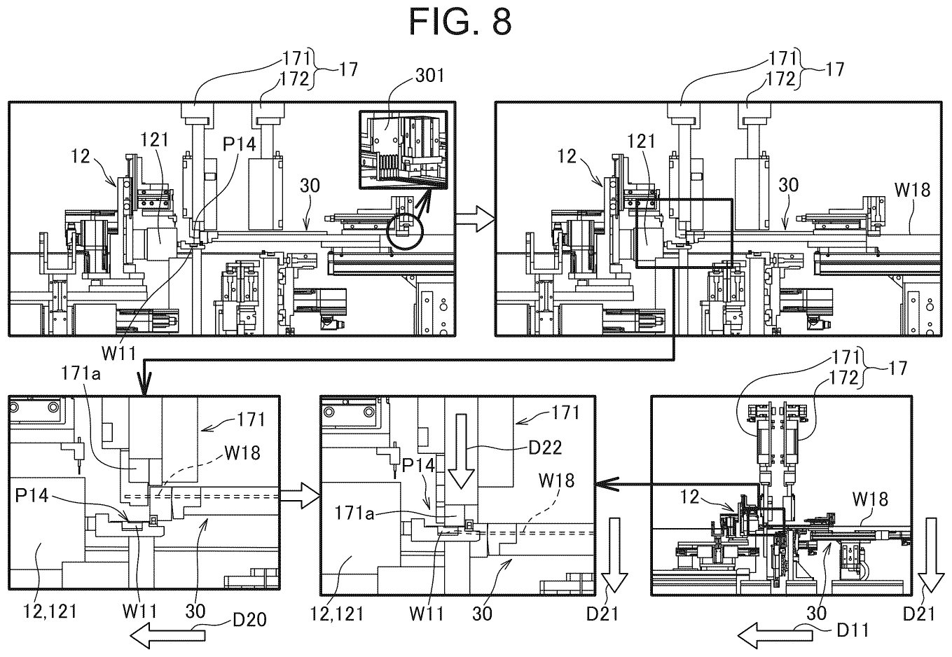

FIG. 8 is a view showing portions where the electric wires are connected to the tip-end connectors in the connector connection portions as shown in FIG. 1 and FIG. 2, together with the flow of the electric wire connection. In this FIG. 8, the right side in the figure refers to the side of the electric wire shelf 11, and the left side in the figure refers to the side facing the above-described tip-end connector mounting position P13.

As shown in FIG. 8, the connector connection portion 17 includes a tip-end connector connection portion 171 of connecting the electric wires W18 to the tip-end connector W11 at a tip-end connection position P14 as the pulling-out root side. At the time of connecting the tip-end connectors W11, the sliding portion 12 moves in a straight line toward the pulling-out root side so as to position the tip-end connector W11 of the retaining portion 121 toward the tip-end connection position P14. Also, this connector connection portion 17 includes a rear-end connector connection portion 172 to be adjacent to the pulling-out root side in the tip-end connector connection portion 171. The rear-end connector connection portion 172 is a portion of connecting the electric wire W18 to the rear-end connector W12. The rear-end connector connection portion 172 will be described by referring to other figures below, and hereafter, the tip-end connector connection portion 171 will be described by referring to FIG. 8.

At the pulling-out root side of the tip-end connector connection portion 171, an electric-wire guide portion 30 configured to guide and send the tip end of the electric wires W18 being pulled out from the electric wire shelf 11 to the tip-end connector connection portion 171 is arranged to dive below the rear-end connector connection portion 172. The electric-wire guide portion 30 includes a comb-shaped electric-wire guide 301 at the side of the electric wire shelf 11, and due to this electric-wire guide 301, the tip ends of the electric wires W18 are guided to the tip-end connector connection portion 171 in the state in which the electric wires W18 are aligned. Before the crimping, this electric-wire guide portion 30 sends in the tip ends of the electric wires W18 toward a crimping portion 171a in the tip-end connector connection portion 171 in a feed-in direction D20 at approximately 25 mm. Furthermore, the electric-wire guiding portion 30 slightly descends in a position alignment direction D21 to align the tip ends of the electric wires W18 to the tip-end connector W11 at the tip-end connection position P14. After this position alignment, the crimping portion 171a of the tip-end connector connection portion 171 descends in a crimping direction D22 to connect the tip ends of the electric wires W18 to the tip-end connectors W11 by crimping.

According to the present embodiment, in the connector connection portion 17, the tip-end connector connection portions 171 and the rear-end connector connection portions 172 are provided in a plural to line up in the orthogonal direction D13 of the apparatus for manufacturing wire harness 1. The connections of the electric wires W18 to the tip-end connectors W11 are performed sequentially in the orthogonal direction D13 with respect to the tip-end connectors W11 of the 9 rows of the sliding portions 12 by the plurality of tip-end connector connection portions 171. Accordingly, the pressure applied by the apparatus for manufacturing wire harness 1 to the metal frame 28 during the crimping is distributed.

In this manner, when the electric wires W18 are connected to the tip-end connectors W11, the sliding portion 12 moves in the pulling-out direction D11 of the electric wires W18. Due to this movement of the sliding portion 12, the electric wires W18 are pulled out from the electric wire shelf 11 at a necessary length for forming the wire harness W1 and then transition to the post-processing such as the branch formation, tape winding or the like. At an appropriate timing in the post-processing, the connections of the rear-end connectors of the electric wires W18 to the rear-end connectors W12 are performed by the rear-end connector connection portions 172. Here, according to the present embodiment, before the connection by the rear-end connector connection portions 172, the supply of the rear-end connectors W12 is performed by the rear-end connector supply portion 16.

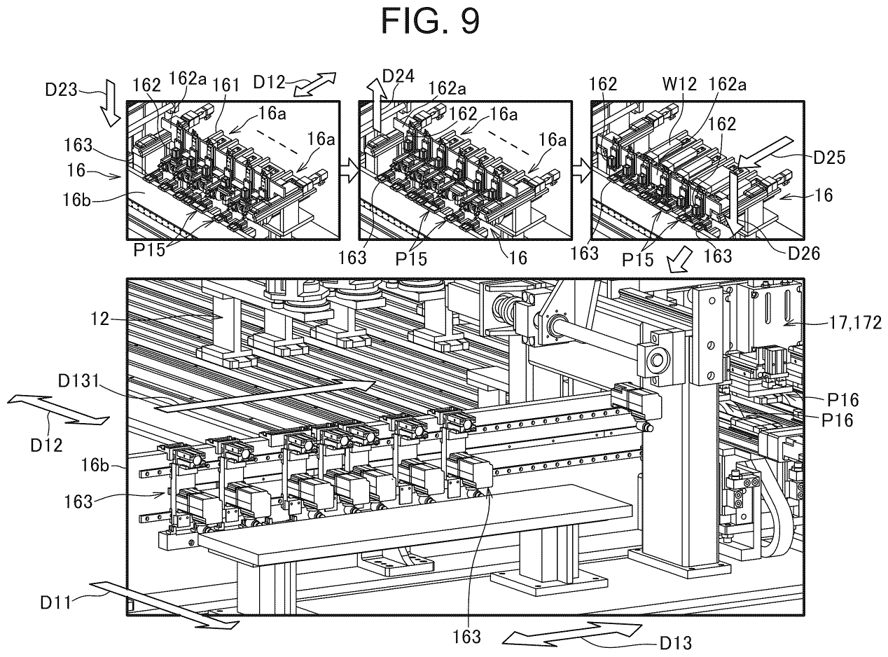

FIG. 9 is a view showing the rear-end connector supply portion as shown in FIG. 1 and FIG. 2 together with the flow of the connector supply.

The rear-end connector supply portion 16 includes a plurality of rear-end supply mechanism 16a, and connector rails 16b configured to support the rear-end connector movement portion 163 of each rear-end supply mechanism 16a described below so as to be movable in the orthogonal direction D13. Then, each rear-end supply mechanism 16a includes a rear-end stocker 161, a rear-end connector mounting portion 162, and a rear-end connector movement portion 163 in a one-to-one correspondence to each other.

In the rear-end stocker 161, the rear-end connectors W12 as the insulation displacement connectors with a rectangular plate shape are overlapped and stocked in a plural in a thickness direction along the movement direction D12 of the sliding portion 12. According to the present embodiment, among the plurality of rear-end stockers 161, several rear-end stockers 161 are configured to accommodate wide connectors with a width being two times of that of the connectors with standard size as the rear-end connectors W12, and several of other rear-end stockers 161 are configured to accommodate the connectors with standard size as he rear-end connectors W12.

The rear-end connector mounting portion 162 is configured to take the rear-end connector W12 out from the rear-end stocker 161 one by one and to mount them in the rear-end connector movement portion 163. During the mounting, a support bridge 162a supporting the plurality of rear-end connector mounting portions 162 moves to position each rear-end connector mounting portion 162 at a taking-out position of the rear-end connector W12 in each rear-end stocker 161. At this taking-out position, each rear-end connector mounting portion 162 descends in a descending direction D23 toward the rear-end connector W12 of each rear-end stocker 161 to catch the rear-end connector W12.

Subsequently, each rear-end connector mounting portion 162 ascends in an ascending direction D24 while catching the rear-end connector W12, the support bridge 162a moves in a sliding direction D25 along the movement direction D12 to be positioned above the rear-end connector mounting position P15. This rear-end connector mounting position P15 becomes a position being offset from the rear-end connection position P16 to which the electric wires W18 are connected by the connector connection portion 17 in the orthogonal direction D13 with respect to the pulling-out direction D11 of the electric wires W18, at the pulling-out root side of the electric wires W18. When reaching the position above each rear-end connector mounting position P15, each rear-end connector mounting portion 162 descends in the descending direction D26 to mount the rear-end connectors W12 to the rear-end connector movement portion 163 waiting at the rear-end connector mounting position P15.

When the rear-end connectors W12 are mounted in this manner, after the mounting, the plurality of rear-end connector movement portions 163 moves in a positioning direction D131 along the orthogonal direction D13 so as to position the rear-end connectors W12 to the rear-end connection position P16. After this positioning, the connection of the electric wires W18 with respect to the rear-end connectors W12 are performed by the rear-end connector connection portion 172 in the connector connection portion 17.

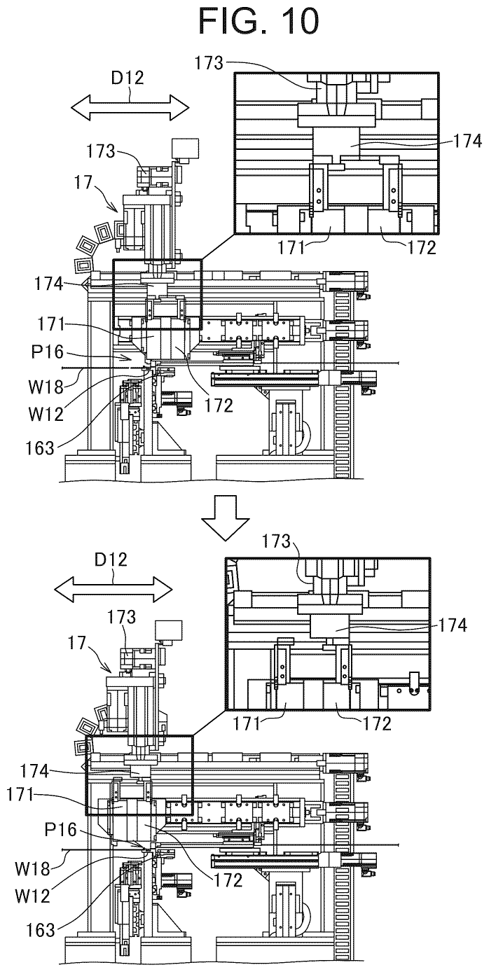

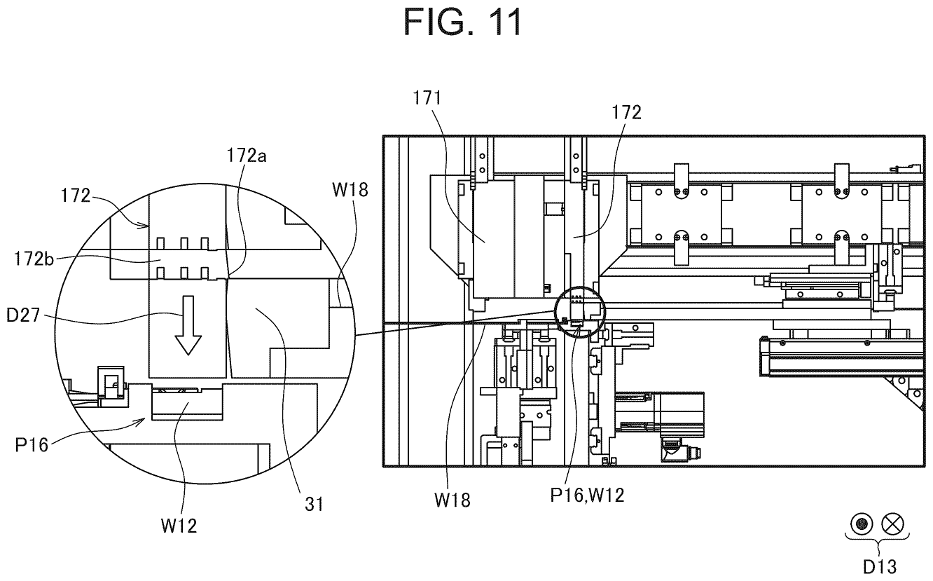

FIG. 10 is a view showing a portion in the connector connection portion where the electric wires are connected to the rear-end connectors as shown in FIG. 1 and FIG. 2, together with an initial operation of a flow of electric-wire connection. Also, FIG. 11 is a view showing the electric-wire connection operations being subsequent to the initial operation shown in FIG. 10 in the connector connection portion. In these FIG. 10 and FIG. 11, the right side in the figures is the side of the electric wire shelf 11, and the left side in the figures is the side toward the above-described rear-end connection position P16.

According to the present embodiment, as described in FIG. 8, in the connector connection portion 17, the tip-end connector connection portion 171 and the rear-end connector connection portion 172 are arranged to be adjacent to each other. In the movement direction D12 of the sliding portion 12, the tip-end connector connection portion 171 is arranged at the pulling-out destination side (second-end side) of the electric wires W18, and the rear-end connector connection portion 172 is arranged at the pulling-out root side (first-end side) as the side of the electric wire shelf 11. At this time, the connector connection portion 17 includes a driving source 173 of the crimping operations, and a transmission mechanism 174 configured to transmit the output of this driving source 173 to the tip-end connector connection portion 171 and the rear-end connector connection portion 172 in a switchable manner. The connection operations by the tip-end connector connection portion 171 that are described by referring to FIG. 8 is performed in a state in which the driving source 173 and the tip-end connector connection portion 171 are connected by the transmission mechanism 174. Then, in the pre-stage of the connection operation by the rear-end connector connection portion 172, the connector connection portion 17 is kept in the state when the connection operation by the tip-end connector connection portion 171 is performed in advance. That is, as shown in the upper segment of FIG. 10, the transmission mechanism 174 is in the state of connecting the driving source 173 to the tip-end connector connection portion 171. In the initial operations during the flow of the electric-wire connection, as shown in the lower segment of FIG. 10, the transmission mechanism 174 switches the transmission destination of the driving source 173 to the rear-end connector connection portion 172. At the same time, the connector connection portion 17 moves along the movement direction D12 such that the rear-end connector connection portion 172 is positioned above the rear-end connection position P16. At the rear-end connection position P16, the rear-end connector W12 is positioned by the rear-end connector movement portion 163.

In this manner, as the initial operation shown in FIG. 10 is finished, as shown in FIG. 11, the connection operations of the electric wires W18 by the rear-end connector connection portion 172 is performed. The rear-end connector connection portion 172 includes an electric-wire cutting blade 172a and a crimping portion 172b at the tip end portion in the up-down direction. Also, in the portion to retain the electric wires W18 before the crimping between the tip-end portion of the rear-end connector connection portion 172 and the rear-end connector W12 at the rear-end connection position P16, an electric-wire cutting lower mold 31 against which the electric-wire cutting blade 172a rubs during the crimping is disposed. Then, after the initial operations, the rear-end connector connection portion 172 moves toward the rear-end connector W12 in the crimping direction D27. Due to this movement, at first, the electric-wire cutting blade 172a sandwiches the electric wires W18 therebetween with the electric-wire cutting lower mold 31 to cut the electric wires W18 from the side of the electric wire shelf 11 and then the crimping portion 172b connects the electric wires W18 at the pulling-out side that have been cut to the rear-end connector W12 by crimping.

As described above, regarding the connector connection portion 17, the tip-end connector connection portion 171 and the rear-end connector connection portion 172 are provided in a plural to line up in the orthogonal direction D13 of the apparatus for manufacturing wire harness 1. The connections of the electric wires W18 to the rear-end connector W12 are performed sequentially with respect to the plurality of rear-end connectors W12 in the orthogonal direction D13 by the plurality of rear-end connector connection portions 172. Accordingly, regarding the rear end side, the pressure applied to the metal frame 28 of the apparatus for manufacturing wire harness 1 during the crimping is distributed.

The branch formation of the wire harness W1 including winding tapes is performed at each timing before and after the connection of the electric wires W18 to the rear-end connectors W12 from the process of pulling out the electric wires W18 by the sliding portion 12 after the connection of the tip-end connectors W11.

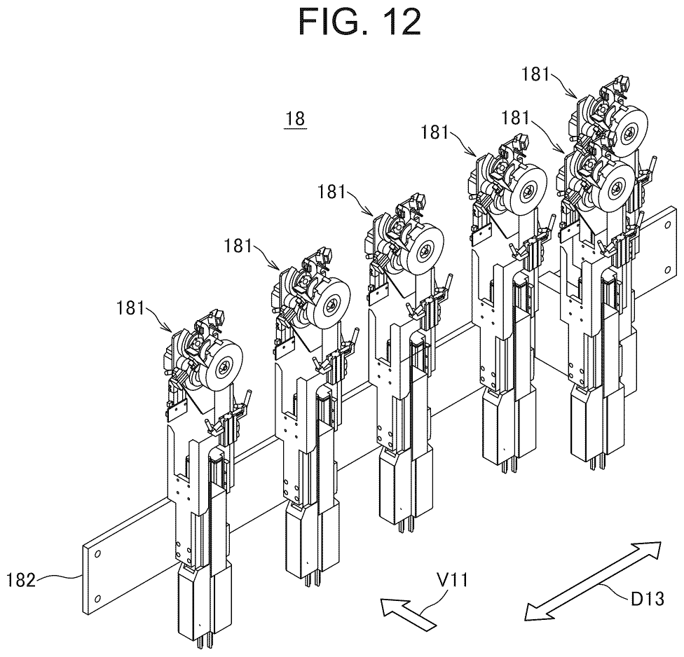

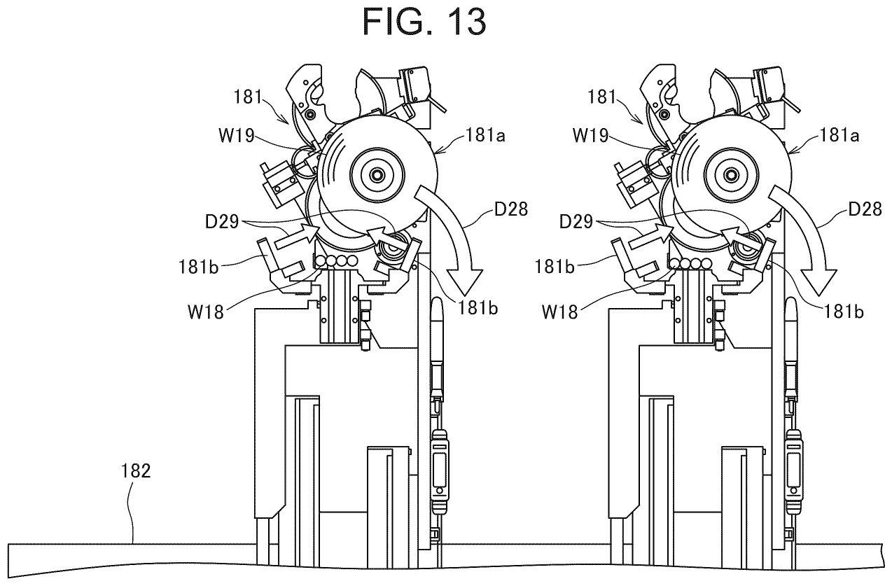

FIG. 12 is a perspective view showing the fixed tape winding mechanism as shown in FIG. 1 and FIG. 2, FIG. 13 is a planar view showing an under-pulling tape winding portion included in the fixed tape winding mechanism shown in FIG. 12 when viewed from a direction of arrow V11 in FIG. 12.

The fixed tape winding mechanism 18 described above is a mechanism that is fixedly provided at the pulling-out root side of the electric wires W18 and configured to perform the tape winding with respect to the electric wires W18 under the process of being pulled out by the sliding portion 12, and it includes six of under-pulling tape winding portions 181 and a support rail 182.

The six of under-pulling tape winding portions 181 are arranged to line up in the orthogonal direction D13 in the apparatus for manufacturing wire harness 1. According to the present embodiment, the under-puling-out tape winding portions 181 are arranged to be in one-to-one correspondence with six rows excluding predetermined three rows among the 9 rows of sliding portions 12 so as to be able to perform the tape winding with respect to the electric wires W18 that are pulled out by each row of sliding portions 12. Each under-pulling tape winding portion 181 makes a tape reel 181a to rotate in a reel rotation direction D28 with each row of electric wires W18 as the center while winding and bundling the tapes W19 being pulled out from this tape reel 181a to the corresponding row of electric wires W18.

Furthermore, each under-pulling tape winding portion 181 includes a pair of retaining arms 181b to retain the electric wires W18 as the target of tape winding. The pair of retaining arms 181b are mechanical portions arranged so as to clamp the electric wires W18 as the tape winding targets and close them in a clamping direction D29 during the tape winding. The electric wires W18 being pulled out by the sliding portion 12 are retained by the pair of retaining arms 181b such that they can be processed by the tape winding by the tapes W19 from the tape reel 181a in a stable state. Also, according to the present embodiment, the six of under-pulling-out tape winding portions 181 are configured to rotate the tape reel 181a in the same reel rotation direction D28.

The tape winding during the pulling out as described in this manner is performed with respect to the electric wires W18 being pulled out by part of the sliding portions 12 that are determined in advance among the 9 rows of sliding portions 12. Then, the tape winding is performed with respect thereto, and the electric wires W18 are pulled out only at the necessary length for forming the wire harness 1. The pulling-out amount of the electric wires W18 is grasped by the control portion 27 as the movement amount of each sliding portion 12, and the control portion 27 sequentially stops the movement of the sliding portions 12 where the pulling amount corresponding to the necessary length has been pulled out. At the time of stopping the movement, under the control of the control portion 27, the electric-wire grasping/additional-length-applying portion 19 grasps the plurality of electric wires W18 being pulled out by the sliding portions 12 in a releasable manner at the pulling our root side. Furthermore, the electric-wire grasping/additional-length-applying portion 19 performs the processing of further pulling out the additional length with respect to part of electric wires W18 after the pulling-out by the sliding portions 12.

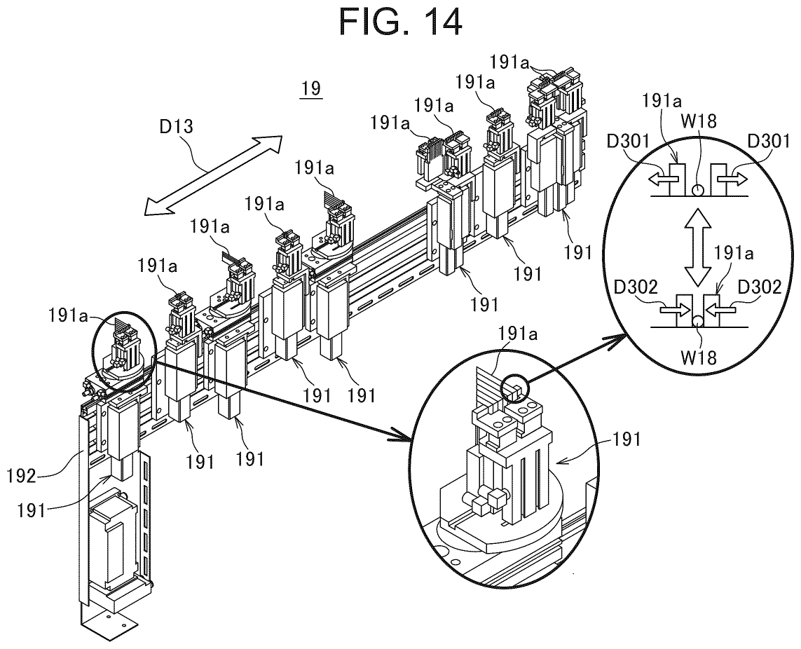

FIG. 14 is a perspective view showing the electric-wire grasping/additional-length-applying portion as shown in FIG. 1 and FIG. 2.

The electric-wire grasping/additional-length-applying portion 19 includes 8 rows of grasping units 191, wherein each is configured to grasp the electric wires W18 with a comb-shaped electric-wire grasping mechanism 191a (electric-wire grasping portion), corresponding to the array with 8 rows excluding one predetermined row among the array with 9 rows of sliding portions 12 in one-to-one correspondence. These 8 rows of grasping units 191 are supported in the orthogonal direction D13 by the support rail 192 in an arranged state. The electric-wire grasping mechanism 191a in each grasping unit 191 becomes the mechanism of switching the grasping state and the ungrasping state of the electric wires W18 by opening and closing the interval of the comb teeth in an opening direction D301 and a closing direction D302. Then, among the 8 rows of the grasping units 191, the electric-wire grasping mechanism 191a in the predetermined three rows of grasping units 191 have the shape corresponding to pulling out the additional length of the electric wires W18.

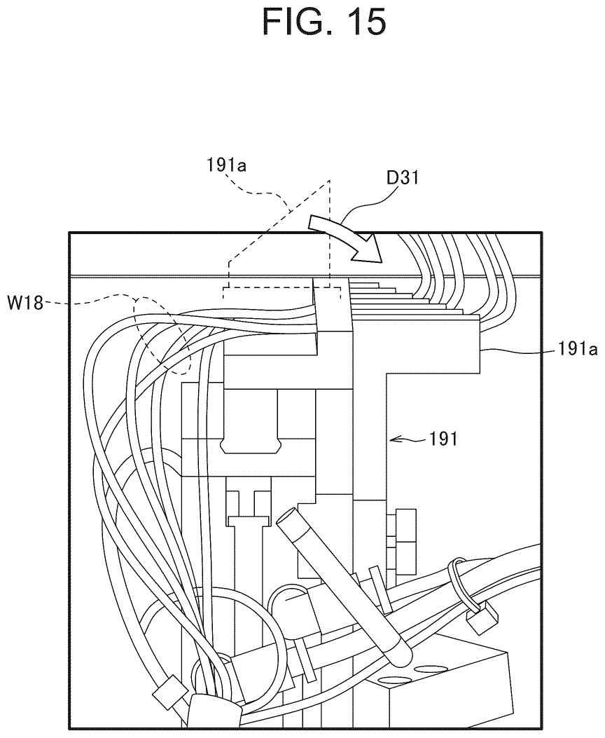

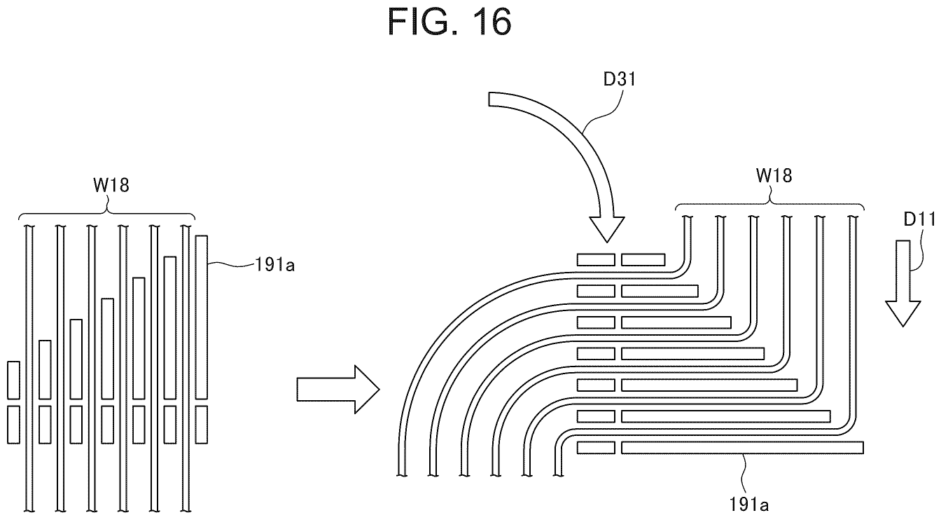

FIG. 15 is a perspective view showing a situation in which the additional length of the electric wires are pulled out by the electric-wire grasping mechanism corresponding to pulling out the additional-length as shown in FIG. 14, and FIG. 16 is a planar view schematically show the situation in which the additional length of the electric wires are pulled out by the electric-wire grasping mechanism as shown in FIG. 15.

According to the present embodiment, the electric-wire grasping mechanism 191a of the grasping unit 191 corresponding to pulling out the additional length has a shape in which the lengths of the plurality of comb teeth are gradually increased toward the right side in the figure. At the time of pulling out the additional length, this electric-wire grasping mechanism 191a is switched to the ungrasping state of the electric wires W18 and rotated toward the right side in the figure, that is, in an additional-length rotation direction D31 toward the side of the longest comb tooth by 90 degrees. As a result, the electric wire W18 is pulled out in the pulling-out direction D11 by the comb teeth sandwiching each electric wire W18. As shown in FIG. 16, the pulling-out amount at this time increases as the comb teeth pulling out the electric wires W18 are longer. In the wire harness W1, the part where the additional length is pulled out becomes the part corresponding to the bending arrangement wherein the short side of the additional length is arranged on the inside and the long side thereof is arranged on the outside. By providing each electric wire W18 with a stepwise additional length as described above, it is possible to naturally bend the harness part when performing the above-described bending arrangement, and it is possible to suppress the load due to the bending in the electric wire W18 in this part.

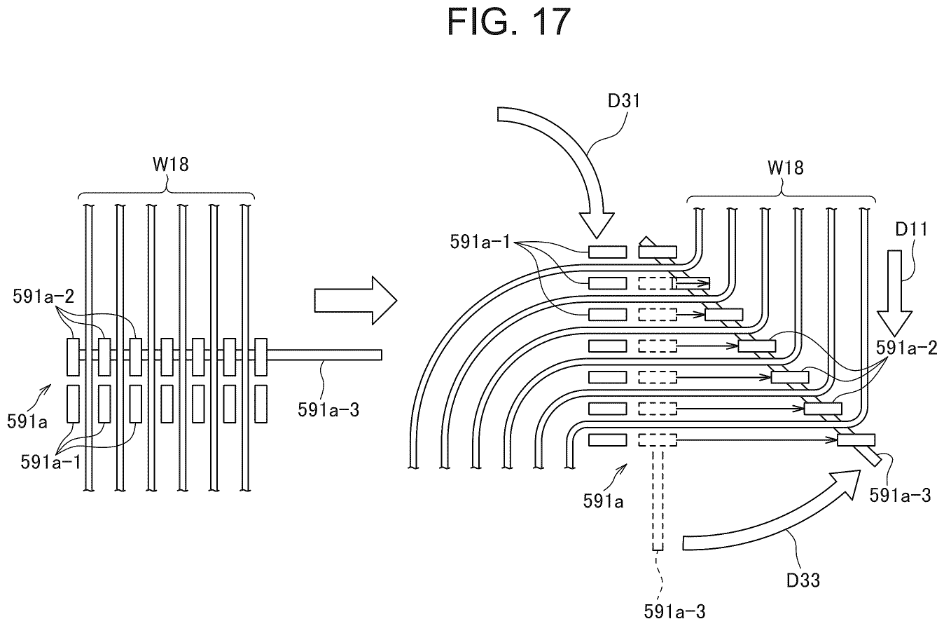

FIG. 17 is a view showing a modification example of the electric-wire grasping mechanism shown in FIG. 16 in a schematic planar view similar to FIG. 16.

An electric-wire grasping mechanism 591 a according to the modification example shown in FIG. 17 includes a fixing end portion 591a-1 whose position in the longitudinal direction of the electric wire W18 is fixed, a movable moving end portion 591a-2, and a support rod 591a-3 to support the moving end portion 591a-2 in a movable manner. At first, similar to the above-described embodiment, the plurality of fixing end portions 591a-1 are the mechanism configured to switch the grasping state and the ungrasping state of the electric wires W18 by opening and closing the comb teeth. On the other hand, the plurality of moving end portions 591a-2 formed in the same length, which is different from the above-described embodiment. Furthermore, the plurality of moving end portions 591a-2 are supported by the support rod 591a-3 being disposed to intersect the moving end portions 591a-2 such that the intersection angle with respect to this support rod 591a-3 is changeable. Then, when this support rod 591a-3 rotates in a support-rod rotation direction D33 with one end side thereof as the center, each moving end portion 591a-2 moves in a direction separating from the fixing end portion 591a-1 in response to the rotation angle.

The movement amount at this time gradually increases as separating from the rotation center of the support rod 591a-3. That is, according to the present modification example, due to the rotation of this support rod 591a-3, it is possible to achieve the same shape with that of the electric-wire grasping mechanism 191a according to the embodiment shown in FIG. 16. Furthermore, by appropriately setting the rotation amount of the support rod 591a-3, it is possible to adjust the pulling-out amount of the additional length via the movement amount of the moving end portions 591a-2.

The electric-wire grasping mechanism 591 a according to the present modification example can be utilized as follows. At first, the connector positional information indicating how the connectors of the wire harness W1 are arranged in the actual vehicle state is acquired. Subsequently, the rotation angle of the support rod 591a-3 is calculated based on the connector positional information when routing the harness. Furthermore, a movement distance of an end portion at the opposite side with the rotation center of the support rod 591a-3 is calculated based on this calculation result. Then, the driving sources such as a motor or the like are driven based on the calculated movement distance such that the support rod 591a-3 is rotated by a necessary amount by moving the end portions of the support rod 591a-3. Due to this rotation, the plurality of moving end portions 591a-2 move to determine the whole shape of the electric-wire grasping mechanism 591a. As the electric-wire grasping mechanism 591a with the determined shape is rotated in the additional-length rotation direction D31 by 90 degrees similar to the above-described embodiment, the electric wires W18 with the additional length only in response to the determined shape due to the rotation of the support rod 591a-3 are pulled out in the pulling-out direction D11. In this manner, according to the configuration of this modification example, it is possible to perform the pulling out of the additional length in response to the connector arrangement in the actual vehicle state.

The pulling out of the electric wires including the additional length and the tape winding at the pulling-out root side by the fixed tape winding mechanism 18 are basically performed with respect to the electric wires W18 that are connected to the same tip-end connector W11 being retained by each of 9 rows of sliding portions 12. Here, according to the present embodiment, the tip-end connector W11 and the rear-end connector W12 are not in one-to-one correspondence, and a number of the rear-end connectors W12 is fewer. Thus, according to the apparatus for manufacturing wire harness 1 of the present embodiment, apart from the tape winding with respect to the electric wires W18 being connected to the same tip-end connector W11, the process of selectively gathering the electric wires W18 being connected to the different tip-end connectors W11 to form the branch shape is performed. The gathered electric wires W18 are bundled by the tape winding to be connected to one rear-end connector W12 such that the electric wires W18 of the wire harness W1 are collected to the rear-end connectors W12 with the number smaller than that of the tip-end connectors W11. According to the present embodiment, the above-described gathering of the electric wires W18 is performed by a large-scale gathering portion 20 and a small-scale gathering portion provided in the moving tape winding mechanism 22 that will be described below.

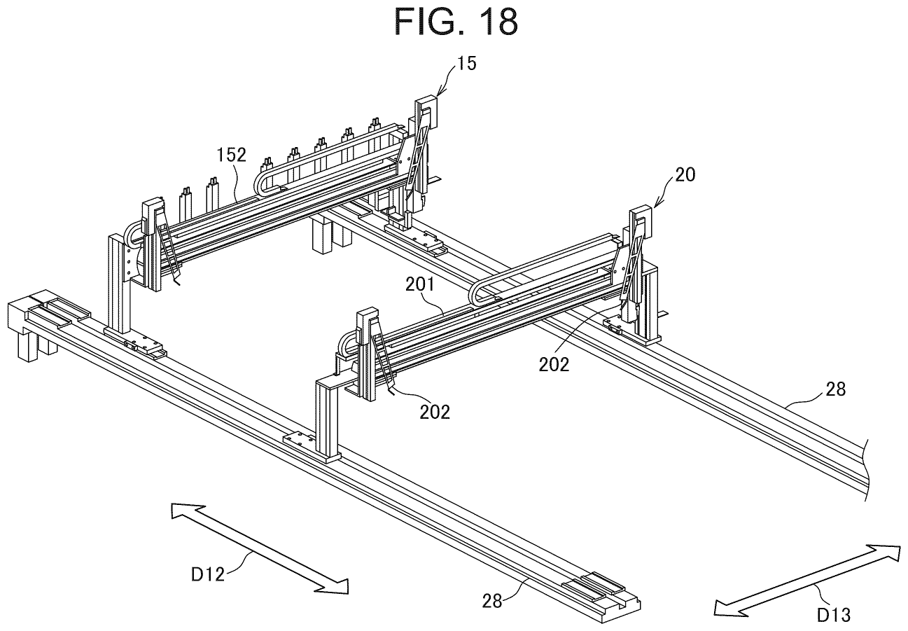

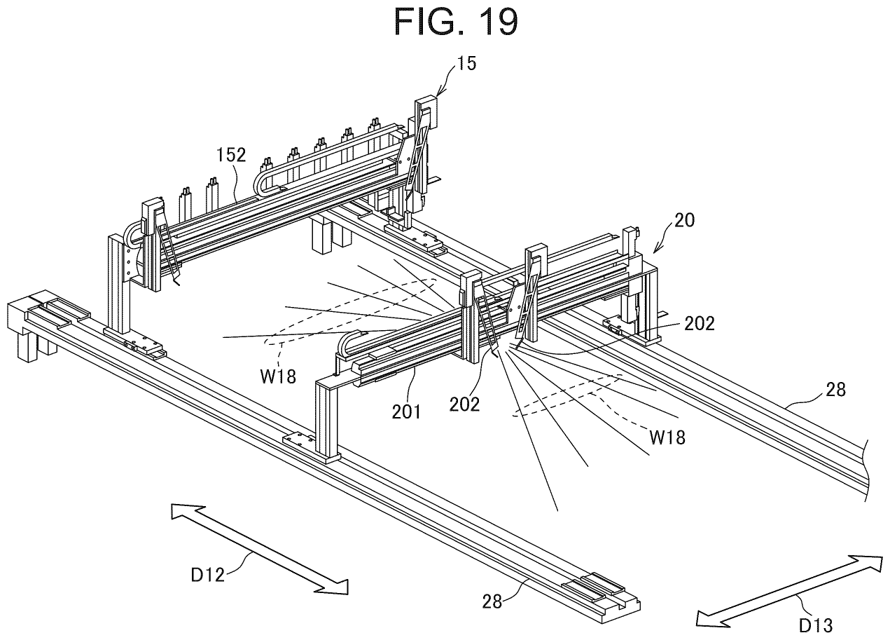

FIG. 18 is a perspective view showing the large-scale gathering portion as shown in FIG. 1 and FIG. 2, and FIG. 19 is a perspective view showing a situation in which the large-scale gathering portion shown in FIG. 18 is gathering the electric wires.

The large-scale gathering portion 20 according to the present embodiment is the mechanism that can gather all of the electric wires W18 that are pulled out by the 9 rows of sliding portions 12 at maximum in the orthogonal direction D13 in the apparatus for manufacturing wire harness 1. This large-scale gathering portion 20 is provided across the metal frames 28 at both sides of the apparatus for manufacturing wire harness 1 while being supported by the metal frames 28 to be movable in the moving direction D12 of the sliding portions 12. The large-scale gathering portion 20 includes a support bridge 201 being supported across the metal frames 28, and a pair of gathering arms 202 being supported by the support bridge 201 to be movable in the orthogonal direction D13. The support bridge 201 moves to a predetermined gathering position and thus the pair of gathering arms 202 are closed such that the plurality of electric wires W18 are gathered and bundled. Also, at this time, the retaining portion 121 in each sliding portion 12 rotates such that the tip-end connectors W11 retained by the retaining portion 121 are directed to make the electric wires W18 are obliquely toward the part bundled by the electric wire gathering.

Also, according to the present embodiment, the same arm mechanism with that of the large-scale gathering portion 20 is also provided in the support bridge 152 of the above-described tip-end connector mounting portion 15, thus it is possible to perform the large-scale electric wire gathering in this tip-end connector mounting portion 15.

On the other hand, the small-scale gathering portion configured to perform the electric wire gathering with a predetermined amount of electric wires being equal to or less than the amount of electric wires that can be gathered by the large-scale gathering portion 20 is provided in the moving tape winding mechanism 22 carried by the robot arm 21.

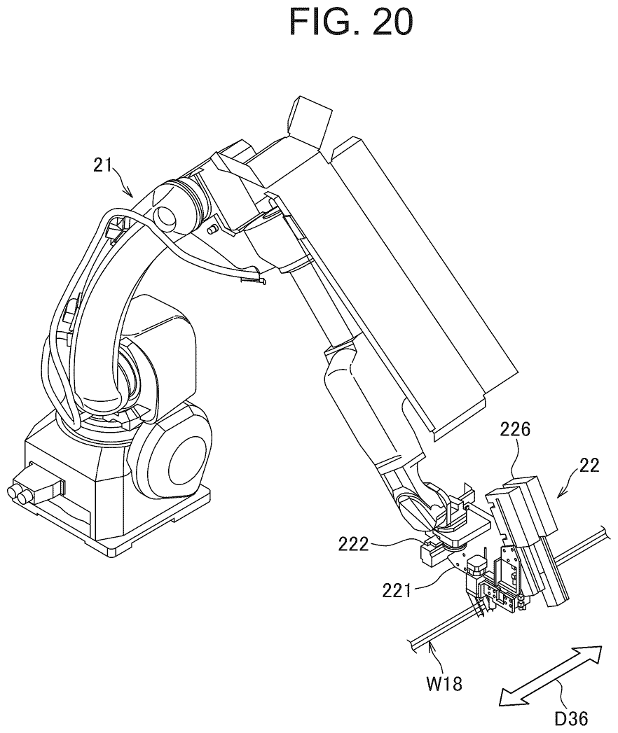

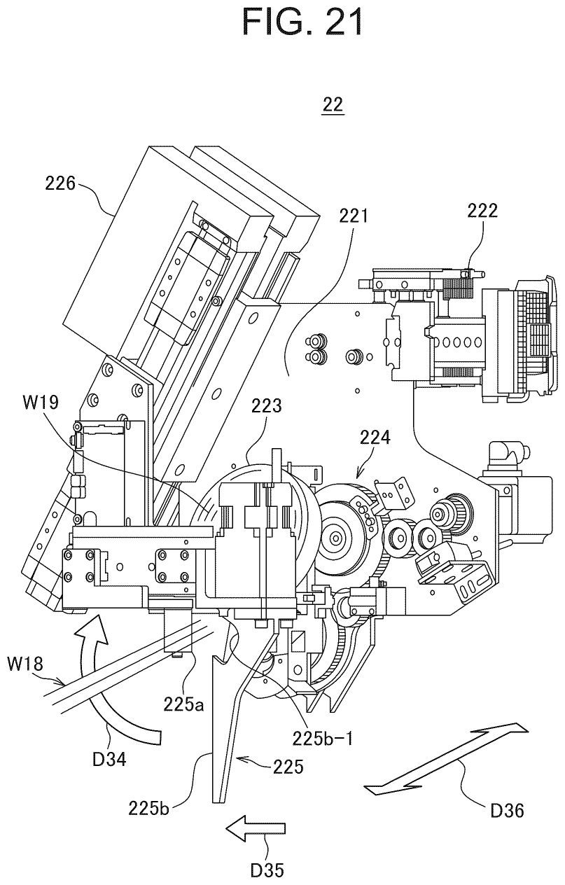

FIG. 20 is a perspective view showing the moving tape winding mechanism shown in FIG. 1 and FIG. 2 together with the robot arm, and FIG. 21 is a perspective view showing the moving tape winding mechanism shown in FIG. 20 as a single item.

The robot arm 21 is an arm mechanism with multiple joints to be provided two on each side of the metal frame 28, and configured to select and grasp one mechanical apparatus from multiple types of mechanism apparatus including the moving tape winding mechanism 22 to transport it to the operation position by the mechanical apparatus.

The moving tape winding mechanism 22 that is transported by this robot arm 21 is the mechanism configured to wind the tapes W19 to the electric wires W18 at the transporting destination. The moving tape winding mechanism 22 includes a mechanical frame 221, a robot arm connection portion 222, a tape reel 223, a reel rotation mechanism 224, a small-scale gathering portion 225, and a driving source 226.

The mechanical frame 221 is a plate-shaped frame for supporting each mechanical portion in the moving tape winding mechanism 22. The robot arm connection portion 222 is a portion configured to be mechanically and electrically connected and grasped by the robot arm 21 and provided in one end edge of the mechanical frame 221. The tape reel 223 is a reel of the tapes W19 for winding, and the reel rotation mechanism 224 is a mechanical portion to retain the tape reel 223 to make it rotate in a reel rotation direction D34 with the electric wire W18 being a target of winding as a center.

The small-scale gathering portion 225 is a mechanical portion configured to perform the electric wire gathering of the electric wires W18, as the targets of tape winding of the tapes W19, with the amount of electric wires being equal to or less than a predetermined amount that is less than the amount of electric wires at the large-scale gathering portion 20. This small-scale gather portion 225 includes a roller 225a and a gathering blade 225b.

Either roller 225a and the gathering blade 225b is disposed to extend in a direction intersecting the electric wires W18 during the tape winding. On the edge in the gathering blade 225b at the side of the roller 225a, a receiving concave portion 225b-1 to receive the electric wires W18 is formed, and the roller 225a is disposed such that the circumference thereof faces this receiving concave portion 225b-1. During the tape winding, the gathering blade 225b receives the electric wires W18 into the receiving concave portion 225b-1 while moving in an electric-wire clamping direction D35 toward the circumference of the roller 225a to clamp the electric wires W18. The tapes W19 are wound to the gathered and clamped electric wires W18 due to this movement. Also, during the tape winding, the tapes W19 are wound while the robot arm 21 moving the moving tape winding mechanism 22 in a straight line in a tape winding direction D36 along the electric wires W18. Therefore, the tape winding is performed across a predetermined tape winding range.

According to the present embodiment, as described above, as the mechanical apparatus being the grasping target by the robot arm 21, besides the above-described moving tape winding mechanism 22, the clip attachment portion 23, the exterior material attachment portion 24, the existing-electric-wire arrangement portion 25 and the dispensing portion 26 are provided.

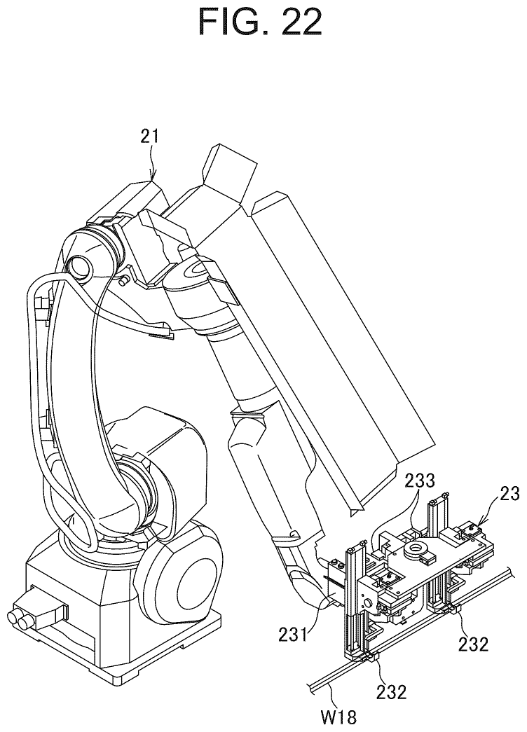

FIG. 22 is a perspective view showing the clip attachment portion as shown in FIG. 1 and FIG. 2 together with the robot arm.

The clip attachment portion 23 is a mechanical portion configured to attach the fixing clip W17 to the electric wires W18, wherein the fixing clip W17 is configured to fix the wire harness W1 being carried by the robot arm 21 to a predetermined fixing destination. This clip attachment portion 23 includes a robot arm connection portion 231, a retaining hook 232 to retain the electric wires W18, and a clip feeding mechanism 233 configured to send the fixing clip W17 therein along the inner circumferential edge of this retaining hook 232 and wind the fixing clip W17 on the electric wires W18. In FIG. 22, the clip attachment portion 23 in which two retaining hooks 232 and two clip feeding mechanism 233 are arranged to line up in the longitudinal direction of the electric wires W18 is shown as an example. According to this clip attachment portion 23, it is possible to simultaneously attach the two fixing clips W17. However, according to the present embodiment, as the clip attachment portion 23, the configuration including three or more than three retaining hooks 232 and clip feeding mechanism 233 being able to simultaneously attach three or more than three fixing clips W17 is also prepared. When manufacturing the wire harness W1, the robot arm 21 selects and carries the clip attachment portion 23 in response to the attachment number of the fixing clips W17 to the attachment location.

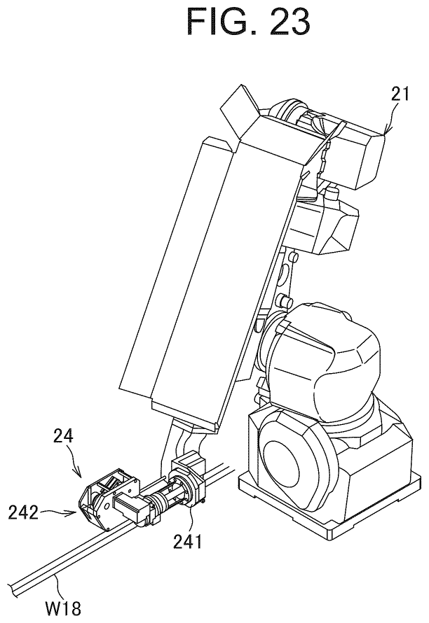

FIG. 23 is a perspective view showing the exterior material attachment portion as shown in FIG. 1 and FIG. 2, together with the robot arm.

The exterior material attachment portion 24 is a mechanical portion configured to perform the attachment of the exterior material W20 such as the corrugated tubes or the like with respect to the electric wires W18 carried by the robot arm 21. This exterior material attachment portion 24 includes a robot arm connection portion 241 and an attachment mechanism 242 configured to send and attach the exterior material W20 along the electric wires W18. In the cylindrical exterior material W20 according to the present embodiment, a slit in the longitudinal direction is formed in the circumferential wall. The attachment mechanism 242 presses the electric wires W18 such that the electric wires W18 is pressed to the inside of the exterior material W20 through the slit, while feeding out the exterior material W20 by a required length and then cutting the exterior material W20. According to the wire harness W1 of the present embodiment, the locations where the tape winding by the above-described tape winding mechanism 22 and the attachment of the fixing clips W17 by the clip attachment portion 23 are performed also exist on the exterior material W20 being attached in this manner.

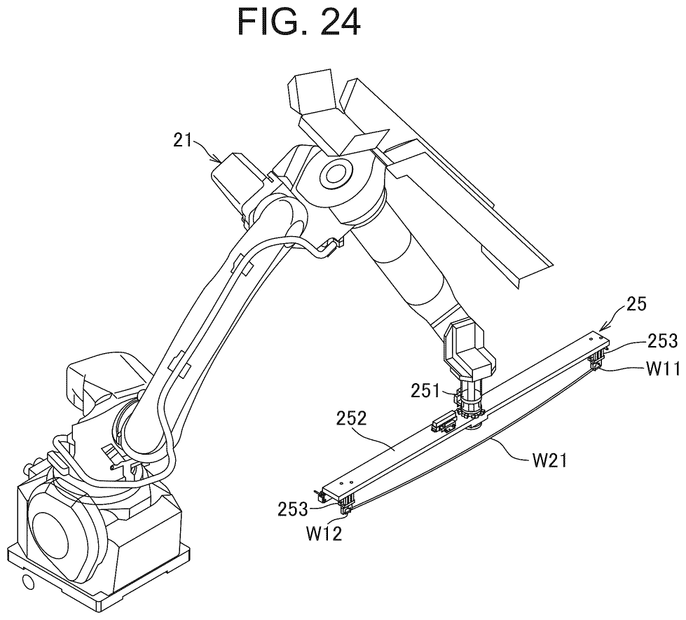

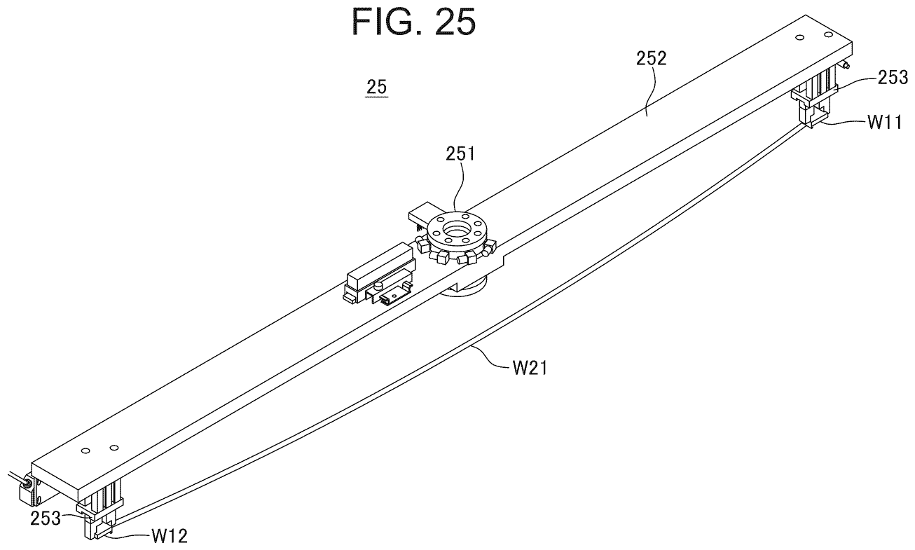

FIG. 24 is a perspective view showing the existing-electric-wire arrangement portion as shown in FIG. 1 and FIG. 2 together with the robot arm, and FIG. 25 is a perspective view showing the existing-electric-wire arrangement portion shown in FIG. 24 as a single item.

The existing-electric-wire arrangement portion 25 is a mechanism configured to retain the existing electric wire W21 where the tip-end connector W11 and the rear-end connector W12 are connected to both ends thereof, and to dispose the existing electric wire W21 to be parallel to the electric wire W18 being pulled out due to the movement of the sliding portion 12 at the destination being transported by the robot arm 21. This existing-electric-wire arrangement portion 25 includes a robot arm connection portion 251, a main body portion 252, and a connector retaining portion 253. The main body portion 252 is a portion with a strip-plate shape extending along the existing electric wire W21, and has the robot arm connection portion 251 in the center thereof. Also, the connector retaining portions 253 are provided one at each end portion of the main body portion 252 and are portions that removably retain the tip-end connector W11 and the rear-end connector W12. Then, the tip-end connector W11 and the rear-end connector W12 are retained by the pair of connector retaining portions 253 such that the existing-electric-wire arrangement portion retains the existing electric wires W21. The robot arm 21 carries the existing-electric-wire arrangement portion 25 retaining the existing electric wire W21 in this manner to one sliding portion 12 and rear-end connector movement portion 163 waiting at the arrangement location of the existing wire W21. Then, at the carrying destination, the existing-electric-wire arrangement portion 25 sets the tip-end connector W11 of the existing electric wire W21 to the retaining portion 121 of the sliding portion 12, and sets the rear-end connector W12 to the rear-end connector movement portion 163. In this manner, the existing electric wire W21 is disposed to be parallel to the electric wire W18 being pulled out by the movement of other sliding portion 12.

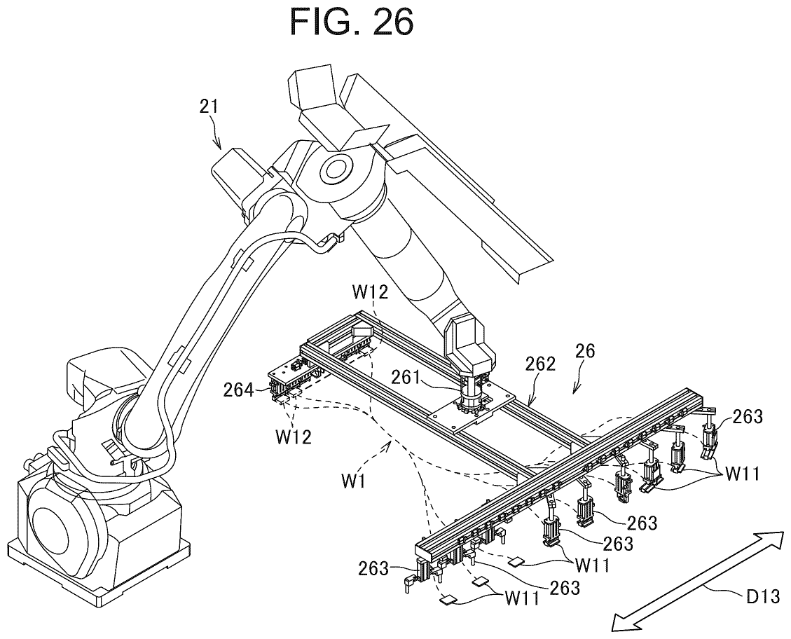

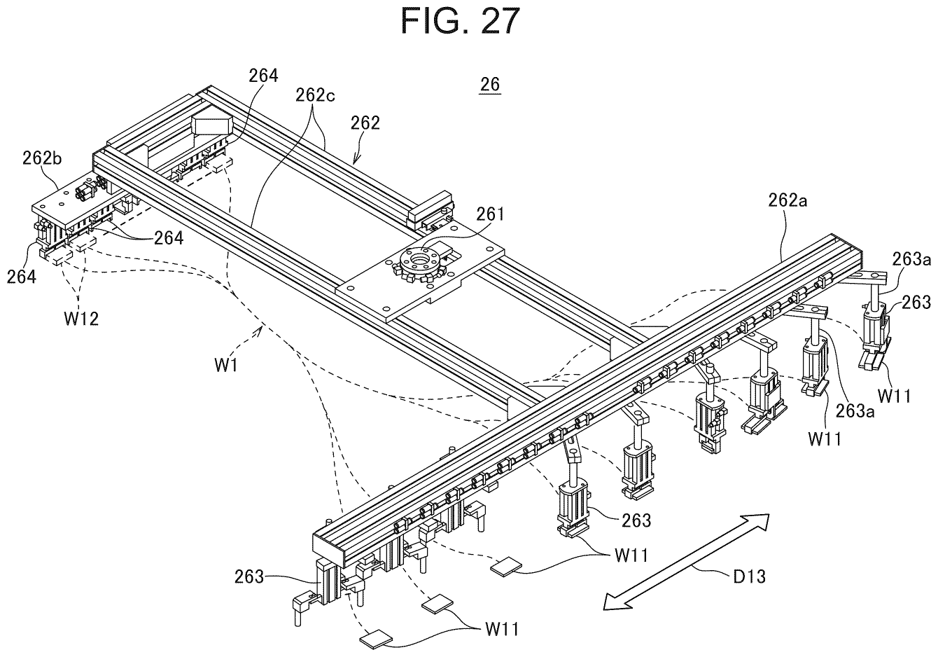

FIG. 26 is a perspective view showing the dispensing portion as shown in FIG. 1 and FIG. 2 together with the robot arm, and FIG. 27 is a perspective view showing the dispensing portion shown in FIG. 26 as a single item.

The dispensing portion 26 retains the finished wire harness W1 and is transported by the robot arm 21 to dispense the wire harness W1 onto the table provides as a dispensing destination 26a. This dispensing portion 26 includes a robot arm connection portion 261, a main body frame 262, a tip-end connector retaining portion 263, and a rear-end connector retaining portion 264.

The main body frame 262 includes a tip-end frame 262a, a rear-end frame 262b, and a middle frame 262c. The tip-end frame 262a is a frame portion with a strip-plate shape that is disposed along the orthogonal direction D13 in which the 9 rows of sliding portions 12 are arranged during the dispensing such that the 9 tip-end connector retaining portions 263 are mounted thereto to line up in a straight line. The rear-end frame 262b is a frame portion with a strip-plate shape that is disposed along the orthogonal direction D13 in which the 6 rear-end connector movement portions 163 are arranged such that the 6 rear-end connector retaining portions 264 are mounted thereto to line up in a straight line. The middle frame 262c is a frame portion with a frame shape connecting the tip-end frame 262a and the rear-end frame 262b, and the robot arm connection portion 261 is provided in the middle portion.

There are 9 tip-end connector retaining portions 263 being mounted to the tip-end frame 262a to line up in a straight line, and each grasps the tip-end connector W11 of the finished wire harness W1 in a releasable manner. Also, the tip-end connector retaining portions 263 are mounted to be rotatable around their support axes 263a respectively so as to grasp the tip-end connector W11 in a posture in response to the orientation of the tip-end connector W11 in the finished wire harness W1.

The rear-end connector retaining portions 264 are mounted to the rear-end frame 262b to line up in a straight line, and each grasps the rear-end connector W12 of the finished wire harness W1 in a releasable manner. The rear-end connector retaining portions 264 grasp the rear-end connectors W12 being retained in the determined orientation by the rear-end connector movement portions 163 respectively so as to be mounted to the rear-end frame 262b in a fixed posture.

During the dispensing by this dispensing portion 26, at first, the sliding portions 12 are lined up in a straight line in the orthogonal direction D13 such that the tip-end connectors W11 in the finished wire harnesses W1 are aligned. Then, the robot arm 21 carries the dispensing portion 26 such that the tip-end connector retaining portions 263 and the rear-end connector retaining portions 264 are positioned on each top portion of those aligned tip-end connectors W11 and the rear-end connectors W12 that have been aligned respectively. After this positioning, the dispensing portion 26 descends such that the tip-end connector retaining portions 263 and the rear-end connector retaining portions 264 retain the tip-end connectors W11 and the rear-end connectors W12. Thereafter, the robot arm 21 rises the dispensing portion 26 so as to remove the tip-end connectors W11 and the rear-end connectors W12 from the sliding portions 12 and the rear-end connector movement portions 163. Then, the robot arm 21 transports the dispensing portion 26 retaining the wire harness W1 by grasping the connectors onto the table as the dispensing destination 26a. When reaching the dispensing destination 26a, the tip-end connector retaining portions 263 and the rear-end connector retaining portions 264 release the tip-end connectors W11 and the rear-end connectors W12 to load the wire harness W1 on the dispensing destination 26a. With the dispensing by this dispensing portion 26, the manufacturing of the wire harness W1 by the apparatus for manufacturing wire harness 1 is finished.

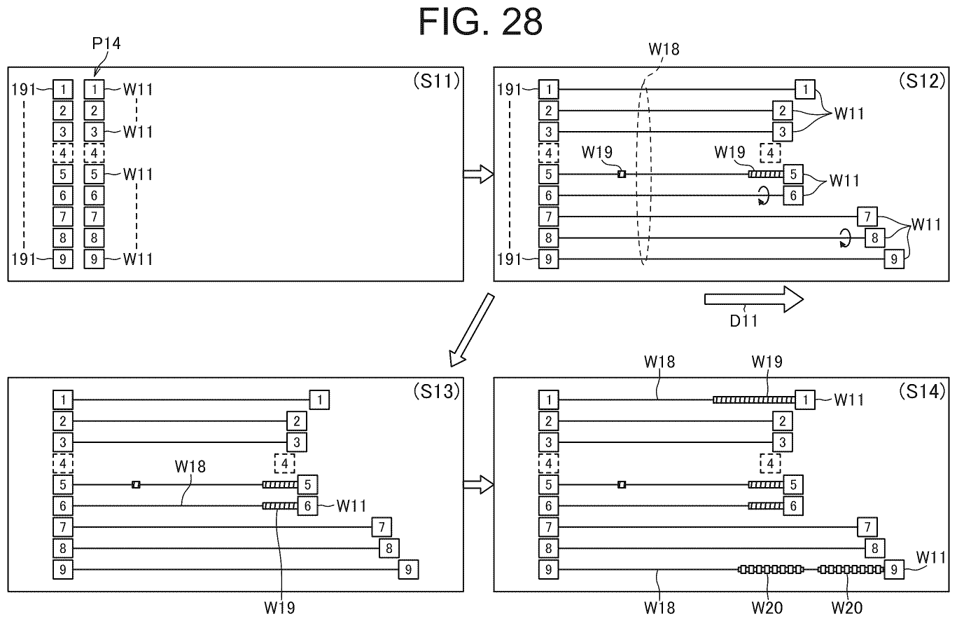

The flow of the method for manufacturing wire harness to manufacture the wire harness W1 by the apparatus for manufacturing wire harness 1, including the detail of each portion, has been described, will be described by referring to FIG. 28 to FIG. 34 schematically showing each processing.

FIG. 28 is a schematic view showing Step S11 to Step S14 of a method for manufacturing wire harness to manufacture the wire harness shown in FIG. 3 by the apparatus for manufacturing wire harness shown in FIG. 1 and FIG. 2.

Step S11 in FIG. 28 is a step in which the electric wires W18 are connected to the 9 tip-end connectors W11 being carried to the tip-end connection positions P14 at the pulling-out root side by the 9 rows of sliding portions 12. At the stage of this Step S11, the rear-end connectors W12 have not been set, and in FIGS. 28, 9 grasping units 191 are shown to face the 9 tip-end end connectors W11. Also, “No. 4” of the tip-end connection position P14 and the grasping unit 191 are shown in dotted lines corresponding to the position where the above-described existing electric wires W21 are set in the post-process.

During Step S12, the 9 rows of sliding portions 12 move in the pulling-out direction D11. This movement is performed under the control of the pulling-out amount of electric-wires by the control portion 27. Therefore, the electric wires W18 connected to the 8 tip-end connectors W11 except for “No. 4” are pulled out at necessary amount. Also, regarding “No. 4”, the sliding portion 12 in an idle state moves to a setting position of the tip-end connector W11 in the existing electric wire W21. During the pulling out in Step S12, the electric-wire grasping mechanism 191a in 9 grasping units 191 are in the ungrasping state and then switch to the grasping state when the pulling out is finished. Also, when the pulling out is finished, each sliding portion 12 pulls the electric wires W18 in the pulling-out direction D11 with a force that balances the grasping force by each electric-wire grasping mechanism 191a in the grasping state to apply a tension and stops. Due to the applying of such tension, the plurality of electric wires W18 are regulated in a parallel state with each other. Basically, the parallel state will be maintained in the following steps in the method for manufacturing wire harness.

Also, during Step S12, the “No. 5” of electric wire W18 is pulled out while receiving the winding of the tapes W19 by the under-pulling tape winding portion 181 of the fixed tape winding mechanism 18 for a certain period of time from the beginning of the pulling. As a result, when the pulling out is finished, the tapes W19 are in the wound state over a predetermined length from the side of the tip-end connector W11. Furthermore, regarding the “No. 5” electric wire W18, when the tape winding is finished, after only the predetermined length has been pulled out, winding of the tapes W19 is shortly performed once again. The tape winding in such a short distance will become a temporary fixing for making the electric wires W18 not to separate apart during the operations in the post-process. After this temporary fixing, the “No. 5” electric wire W18 is pulled out until reaching the necessary length.

Also, in Step S12, regrading “No. 6” and “No. 8” electric wires W18, after the necessary length has been pulled out, the twisting of these electric wires are performed by rotating the retaining portion 121 of the sliding portion 12. Also, in this Step S12, pulling out the electric wires W18 together with the tape winding and the twisting are performed by being appropriately divided into several sessions in order to avoid interferences between the rows.

In Step S13, regarding “No. 6” electric wire W18 after being twisted, the winding of tapes W19 by the moving tape winding mechanism 22 is performed over a predetermined length. At this time, the tape winding is performed while moving the moving tape winding mechanism 22 by the robot arm 21 from the side of the tip-end connector W11 toward the pulling-out root side. Also, the tape winding in the moving tape winding mechanism 22 is performed together with the electric wire gathering with respect to the electric wires W18 as the targets of the tape winding. Here, the electric wire gathering, since the amount of the gathered electric wires are determined by the control portion 27 to be equal to or less than the predetermined amount, is performed by the small-scale gathering portion 225 of the moving tape winding mechanism 22. Hereinafter, the tape winding by the moving tape winding mechanism 22 with respect to the electric wires W18 connected to the same tip-end connector W11 is basically determined that the amount of electric wires in any case is equal to or less than the predetermined amount so as to be performed together with the electric wire gathering by the small-scale gathering portion 225 of the moving tape winding mechanism 22.

In Step S14, the winding of tapes W19 over the predetermined length with respect to “No. 1” electric wire W18 is performed at the side of the tip-end connector W11 by the moving tape winding mechanism 22, and the attachment of the exterior material W20 with respect to the “No. 9” electric wire is performed by the exterior material attachment portion 24. Here, the attachment of the exterior material W20 is performed twice at a certain interval from the side of the tip-end connector W11. Therefore, in the “No. 9” electric wire W18, the exterior materials W20 are attached to two locations including the location at the side of the tip-end connector W11 and the location separating therefrom at a certain distance.

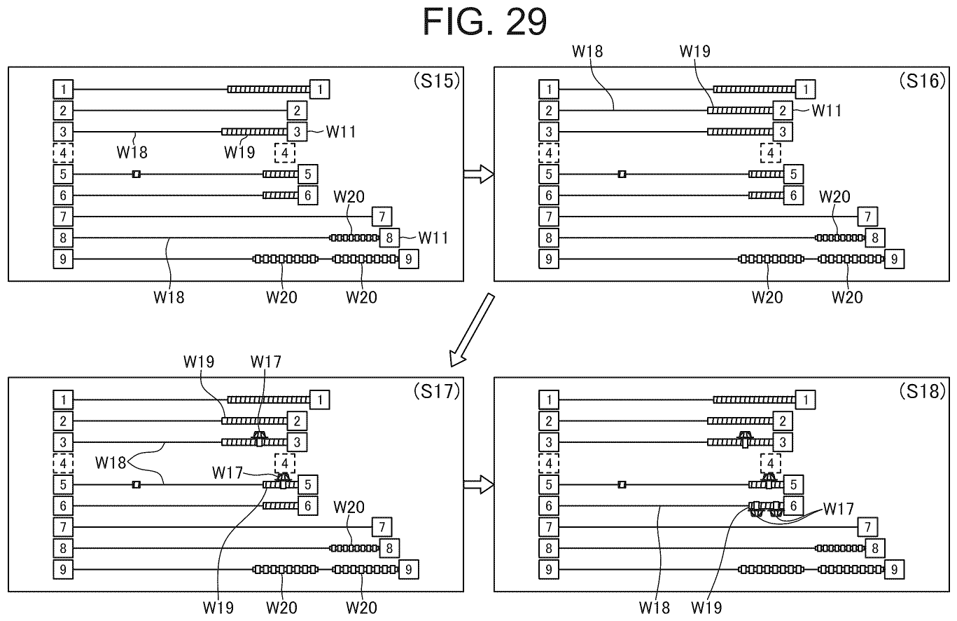

FIG. 29 is a schematic view showing Step S15 to Step S18 of the method for manufacturing wire harness to manufacture the wire harness shown in FIG. 3 by the apparatus for manufacturing wire harness as shown in FIG. 1 and FIG. 2.

In Step S15, the winding of the tapes W19 over the predetermined length with respect to the “No. 3” electric wire W18 is performed by the moving tape winding mechanism 22 from the side of the tip-end connector W11. Also, the attachment of the exterior material W20 with respect to the twisted “No. 8” electric wire W18 is performed by the exterior material attachment portion 24. Here, the attachment of the exterior material W20 is performed once from the side of the tip-end connector W11. Also, in Step S15, regarding “No. 9” exterior material W20, the fixing by the tape winding is performed by the moving tape winding mechanism 22. The tape winding with respect to this exterior material W20 is continued until Step S17.

In Step S16, the winding of tapes W19 over the predetermined length with respect to “No. 2” electric wire W18 is performed by the moving tape winding mechanism 22 at the side of the tip-end connector W11. Also, in Step S16, the fixing by the tape winding with respect to “No. 8” exterior material W20 is performed by the moving tape winding mechanism 22, while the tape winding with respect to the “No. 9” exterior material W20 by the moving tape winding mechanism 22 is continued. Both the tape winding with respect to “No. 8” exterior material W20 and the tape winding with respect to “No. 9” exterior material W20 are continued until Step S17.

In Step S17, with respect to “No. 3” and “No. 5” electric wires W18, the attachment of the fixing clip W17 by the clip attachment portion 23 is performed on the tapes W19.

Here, one fixing clip W17 is attached to each electric wire W18. Also, the tape winding with respect to “No. 8” and “No. 9” exterior materials W20 are finished at Step S17.

In Step S18, with respect to “No. 6” electric wire W18, the attachment of the fixing clip W17 by the clip attachment portion 23 is performed on the tape W19. Here, two fixing clips W17 are attached to the “No. 6” electric wire W18.

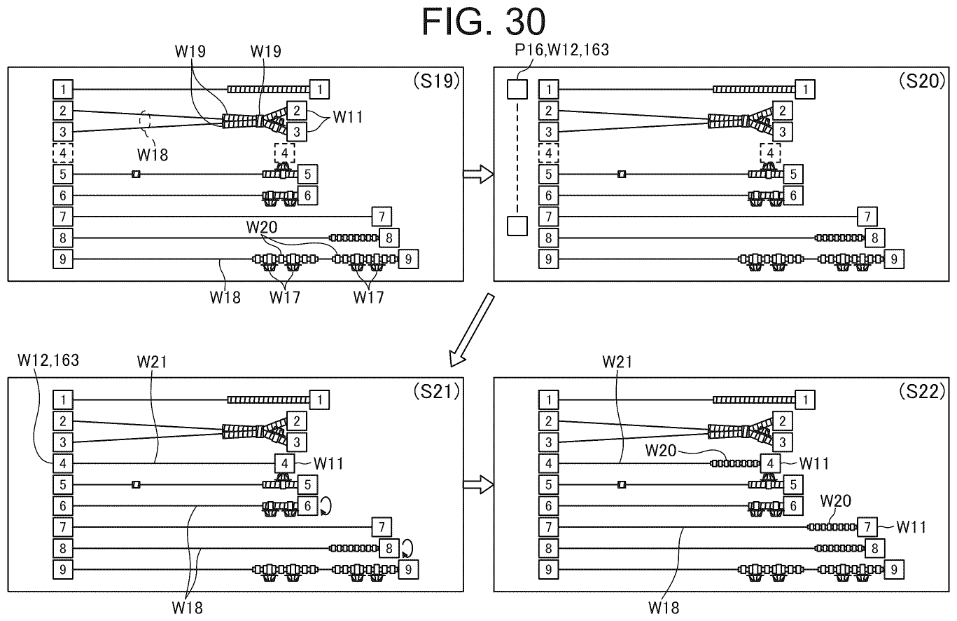

FIG. 30 is a schematic view showing Step S19 to Step S22 of the method for manufacturing wire harness to manufacture the wire harness shown in FIG. 3 by the apparatus for manufacturing wire harness as shown in FIG. 1 and FIG. 2.

In Step S19, both portions, being wound by the tapes W19, of the “No. 2” and “No. 3” electric wires W18 that are connected to different tip-end connectors W11 are further bundled by being wound by the tapes W19. Here, the tape winding is performed together with the electric wire gathering with respect to the electric wires W18 of the different tip-end connectors W11, however, the amount of electric wires is determined to be equal to or less than the predetermined amount, and it is performed together with the electric wire gathering by the small-scale gathering portion 225 of the moving tape winding mechanism 22. Then, one branch is formed by this tape winding.

Also, during the electric wire gathering, the sliding portion 12 of at least one of the “No. 2” and “No. 3” moves toward the pulling-out root side while the retaining portion 121 thereof rotates to direct the tip-end connector W11 toward the direction of the branch point. Due to such operations in the sliding portion 12, the tension applied to each electric wire W18 due to the electric wire gathering is alleviated.

Also, in Step S19, regarding the “No. 9” electric wire W18, the attachment of fixing clips W17 by the clip attachment portion 23 is performed on the exterior materials W20 at two locations. Here, there are two fixing clips W17 being attached to each exterior material W20.

In Step S20, at the pulling-out root side, there are 6 rear-end connectors W12 being transported to the rear-end connection position P16 by the rear-end connector movement portion 163. At this time, regarding “No. 4”, the rear-end connector movement portion 163 in an idle state moves to the position facing the sliding portion 12.

In Step S21, the existing electric wire W21 is transported by the existing-electric-wire arrangement portion 25 to the “No. 4” setting position. Then, at this setting position, the tip-end connector W11 of the existing electric wire W21 is set in the retaining portion 121 of the sliding portion 12, and the rear-end connector W12 is set in the rear-end connector movement portion 163. Also, in Step S21, regarding the twisted “No. 6” and “No. 8” electric wires W18 during the electric-wire pulling out at Step S12, the twisting by the rotation of the retaining portion 121 is performed once again.

In Step S22, the attachment of the exterior materials W20 with respect to each of the “No. 4” existing electric wire W21 and the “No. 7” electric wire W18 are performed by the exterior material attachment portion 24. Here, the attachment of the exterior material W20 is performed once from the side of each tip-end connector W11.

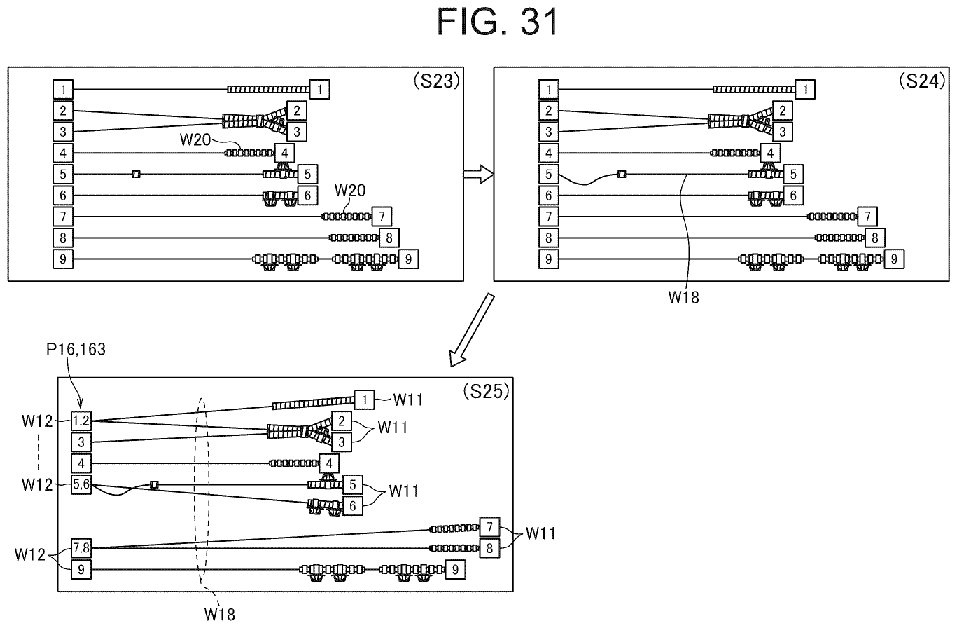

FIG. 31 is a schematic view showing Step S23 to Step S25 of the method for manufacturing wire harness to manufacture the wire harness shown in FIG. 3 by the apparatus for manufacturing wire harness as shown in FIG. 1 and FIG. 2.

In Step S23, regarding the “No. 4” and “No. 7” exterior materials W20, the fixing by the tape winding is performed by the moving tape winding mechanism 22.

In Step S24, regarding the “No. 5” electric wire W18, the pulling out of the additional length is performed by the rotation of the electric-wire grasping mechanism 191a in the grasping unit 191. The temporary fixing formed by the winding of the tapes W19 in the above-described Step S12 is maintained during the rotation of the electric-wire grasping mechanism 191a when pulling out the additional length so as to prevent the electric wires W18 from being separated apart.

In Step S25, the connection and cutting of the electric wires W18 with respect to each of the 6 rear-end connectors W12 being transported to the rear-end connection position P16 in the above-described Step S20 are performed by the rear-end connector connection portion 172 in the connector connection portion 17. Here, according to the present embodiment, the “No. 1” electric wire W18 and the “No. 2” electric wire W18 that are connected to different tip-end connectors W11 are connected to the one rear-end connector W12. Similarly, the “No. 5” electric wire W18 and the “No. 6” electric wire W18 are connected to one rear-end connector W12, and the “No. 7” electric wire W18 and the “No. 8” electric wire W18 are connected to one rear-end connector W12. The connection and cutting of these electric wires W18 from different tip-end connectors W11 to and from one rear-end connector W12 are performed by being divided into twice.

At first, in the rear-end connector connection portion 172, after the connection and the cutting with one rear-end connector W12 regarding the electric wire W18 of one tip-end connector W11 is finished, the rear-end connector movement portion 163 moves this rear-end connector W12. That is, the rear-end connector movement portion 163 moves the rear-end connector W12 to which the electric wire W18 of one tip-end connector W11 is connected to make the width therebetween with the adjacent rear-end connection position P16, wherein it is possible to perform the connection with the adjacent electric wire W18 extending to the adjacent other tip-end connector W11, to be closer. After this width reducing, the adjacent electric wire W18 is connected to the rear-end connector W12 and is simultaneously cut. Such connection and cutting performed twice are performed with respect to each of the “No. 1” and “No. 2” electric wires W18, “No. 5” and “No. 6” electric wires W18, and “No. 7” and “No. 8” electric wires W18.

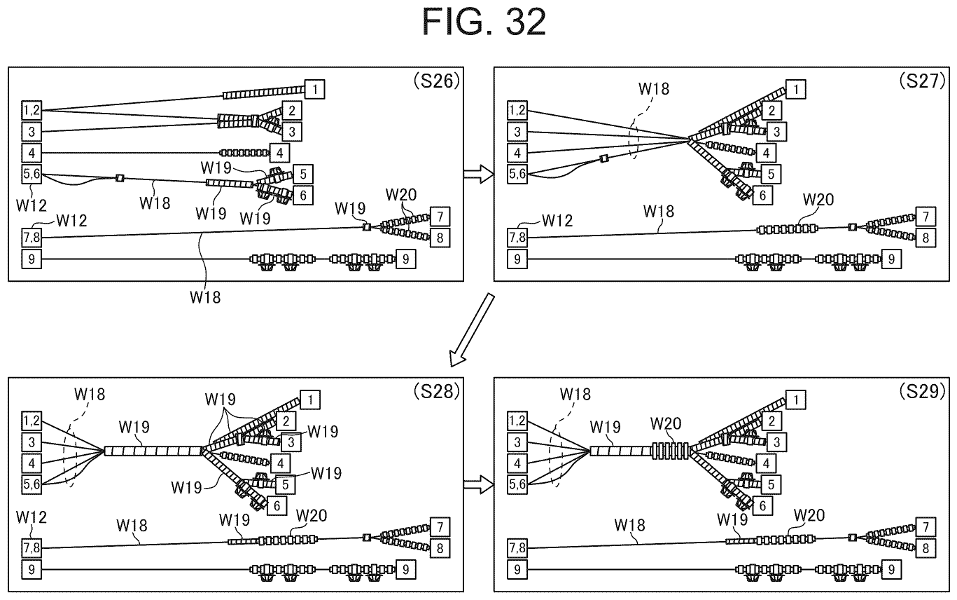

FIG. 32 is a schematic view showing Step S26 to Step S29 of the method for manufacturing wire harness to manufacture the wire harness shown in FIG. 3 by the apparatus for manufacturing wire harness as shown in FIG. 1 and FIG. 2.

In Step S26, the “No. 5” and the “No. 6” electric wires W18 connected to one rear-end connector W12 are bundled by the electric wire gathering, and the tapes W19 are wound over the predetermined length toward the pulling-out root side by the moving-tape winding mechanism 22. Regarding the tape winding described here, the moving tape winding mechanism 22 performs the winding by overlapping the tapes W19 on part at the end portion side in the tapes W19 that have already been wound on each electric wire W18 while moving toward the pulling-out root side. Also, regarding this tape winding, it is determined that the amount of electric wires is equal to or less than the predetermined amount such that it is performed together with the electric wire gathering by the small-scale gathering portion 225 of the moving tape winding mechanism 22. Then, there is one branch being formed by the tape winding described here. Also, at the time of the electric wire gathering described here, the tension applied to each electric wire W18 is alleviated due to the rotation of the retaining portion 121 and the movement of the sliding portion 12. Also, in Step S26, with regard to the “No. 7” and “No. 8” electric wires W18 being connected to one rear-end connector W12, they are bundled due to the electric wire gathering, and the tapes W19 are locally wound at the confluence point as the vicinity of the end of each exterior material 20. Such locally performed tape winding is determined that the amount of electric wires is equal to or less than the predetermined amount, thus it is performed by the moving tape winding mechanism 22 together with the electric wire gathering by the small-scale gathering portion 225. Similar to the situation of “No. 5” and “No. 6”, the electric wire gathering described here is also performed in the state in which the tension applied to each electric wire W18 due to the rotation of the retaining portion 121 and the movement of the sliding portion 12 is alleviated.

In Step S27, the electric wire gathering is performed with respect to the “No. 1” to the “No. 6” electric wires W18, and the “No. 7” electric wire W18 and the “No. 8” electric wire W18 connected to one rear-end connector W12 are attached with the exterior material W20 at a position separating from the branch point.

Regarding the electric wire gathering performed to the “No. 1” to the “No. 6” electric wires W18, the amount of the gathered electric wires is determined to exceed the predetermined amount by the control portion 27 such that it is performed by the large-scale gathering portion 20 rather than the small-scale gathering portion 225 of the moving tape winding mechanism 22. The gathered portion becomes one branch point. Also, during the larger-scale electric wire gathering, substantially all of the “No. 1” to “No. 6” sliding portions 12 move to the pulling-out root side while each retaining portion 121 rotates to direct each tip-end connector W11 toward the branch point. Due to these operations in the sliding portions 12, the tension applied to each electric wire W18 due to the large-scale electric wire gathering is alleviated.

Also, the attachment of the exterior material W20 to the “No. 7” and “No. 8” electric wires W18 are performed once by the exterior material attachment portion 24.

In Step S28, regarding the “No. 1” to “No. 6” electric wires W18 that are gathered in Step S27, the tape winding from the branch point side toward the pulling-out root side is performed by the moving tape winding mechanism 22. The tape winding described here is performed by overlapping and winding the tapes W19 at the branch point side on part of the tapes W19 that has been wound in each electric wire W18 while moving the moving-tape winding mechanism 22 further toward the pulling-out root side.

Also, in Step S28, regarding the “No. 7” and “No. 8” electric wires W18 connected to one rear-end connector W12, the fixing by winding the tapes W19 to the exterior material W20 attached in Step S27 is performed by the moving tape winding mechanism 22. The tape winding with respect to this exterior material W20 is continued until the next Step S29.

In Step S29, regarding the “No. 1” to “No. 6” electric wires W18 to which the tape winding is performed in Step S28, the exterior material W20 is attached on the tapes W19 by the exterior material attachment portion 24. The attachment of the exterior material W20 is performed once near the branch point of the electric wires W18. Also, in this Step S29, the tape winding with respect to the exterior material W20 of the “No. 7” and “No. 8” electric wires W18 continuing from Step S28 is finished.

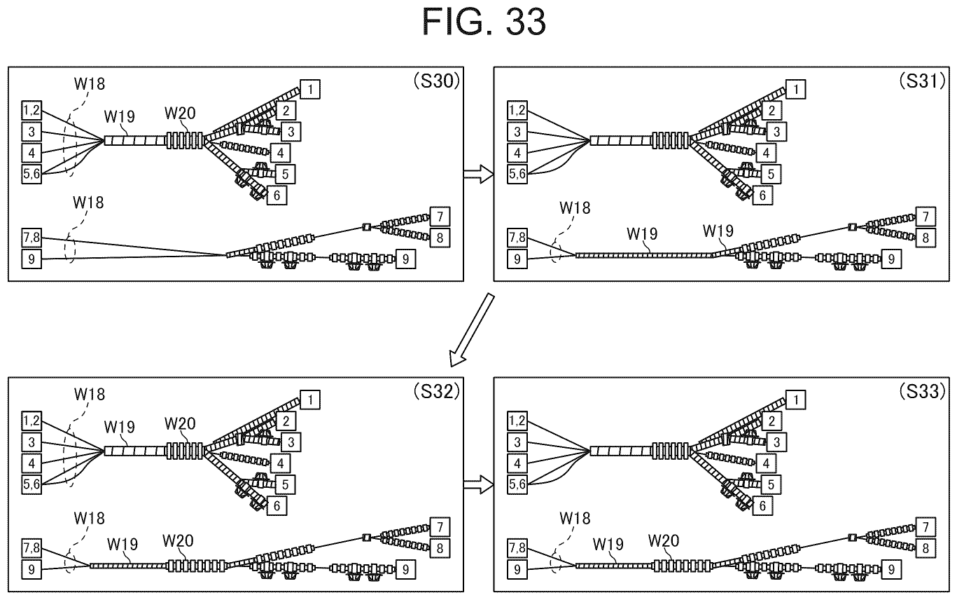

FIG. 33 is a schematic view showing Step S30 to Step S33 of the method for manufacturing wire harness to manufacture the wire harness shown in FIG. 3 by the apparatus for manufacturing wire harness as shown in FIG. 1 and FIG. 2.

In Step S30, the fixing by winding the tapes W19 with respect to the exterior material W20 of the “No. 1” to “No. 6” electric wires W18 is performed by the moving tape winding mechanism 22. The tape winding with respect to the exterior material W20 is continued until Step S32.

Also, in Step S30, the “No. 7” to “No. 9” electric wires W18 are gathered near the end portion of the tape winding with respect to the “No. 7” and “No. 8” electric wires W18. The electric wire gathering described here is determined by the control portion 27 that the amount of gathered electric wires is equal to or less than the predetermined amount such that it is performed by the small-scale gathering portion 225 of the moving tape winding mechanism 22. Also, during the electric wire gathering, the tension applied to each electric wire W18 is alleviated due to the movement of the sliding portion 12 and the rotation of the retaining portion 121.

In Step S31, regarding the “No. 7” to “No. 9” electric wires W18, the tapes W19 are overlapped and wound on part of the tapes W19 at the branch point side that have been wound on each electric wire W18, and the tape winding is performed toward the pulling-out root side. Here, the tape winding is also performed by the moving tape winding mechanism 22.

In Step S32, regarding the “No. 7” to “No. 9” electric wires W18, the exterior material W20 is attached on the tapes W19 that have been wound during the tape winding in Step S31 by the exterior material attachment portion 24. The attachment of the exterior material W20 is performed once from the vicinity of the branch point of the electric wire W18. Also, in this Step S32, the tape winding of the tapes W19 with respect to the exterior material W20 of the “No. 1” to “No. 6” electric wires W18 continued from Step S30 is finished.

In Step S33, the fixing by the tape winding of the tapes W19 with respect to the exterior material W20 of the “No. 7” to “No. 9” electric wires W18 that has been attached in Step S32 is performed by the moving tape winding mechanism 22.

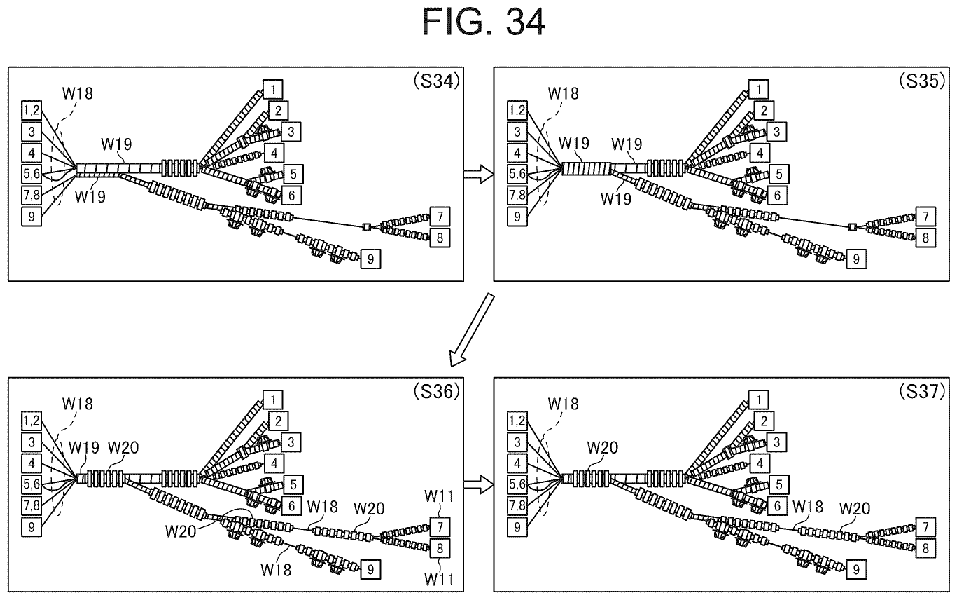

FIG. 34 is a schematic view showing Step S34 to Step S37 of the method for manufacturing wire harness to manufacture the wire harness shown in FIG. 3 by the apparatus for manufacturing wire harness as shown in FIG. 1 and FIG. 2.

In Step S34, the portions of the “No. 1” to “No. 6” electric wires W18 to which the tapes W19 are wound and the portions of the “No. 7” to “No. 9” electric wires W18 to which the tapes W19 are wound are gathered to form the branch. Regarding the electric-wire gathering described here, it is determined that the amount of electric wires exceeds the predetermined amount such that it is performed by the large-scale gathering portion 20.

The gathered portions become one branch point. Also, during the large-scale electric-wire gathering, substantially all of the sliding portions 12 of “No. 1” to “No. 9” sliding portions move toward the pulling-out root side, and each retaining portion 121 rotates to direct each tip-end connector W11 toward the side of the branch point. Due to such operations in the sliding portion 12, the tension applied to each electric wire W18 due to the large-scale electric-wire gathering is alleviated.

In Step S35, from the branch point of the “No. 1” to “No. 9” electric wires W18 toward the pulling-out root side, the tapes W19 are overlapped and wound on the tapes W19 that have been wound on each electric wire W18. The tape winding described here is performed by the moving tape winding mechanism 22. Due to the tape winding in this Step S35, the branch shape in the wire harness W1 as shown in FIG. 3 is determined.

In Step S36, regarding the “No. 1” to “No. 9” electric wires W18, the exterior material W20 is attached on the tapes W19 being wound in Step S35 by the exterior material attachment portion 24. The attachment of the exterior material W20 is performed once from the branch point of the electric wires W18.

Also, in Step S36, regarding the “No. 7” and “No. 8” electric wires W18, the attachment of the exterior material W20 is further performed to the portion between the branch point at the tip-end connector W11 side and the exterior material W20 at the side of the branch point with the “No. 9” electric wire W18. The attachment of the exterior material W20 is performed only once from the branch point at the tip-end connector W11 side by the exterior material attachment portion 24.

In Step S37, the fixing by wounding the tapes W19 with respect to the exterior material W20 of the “No. 1” to “No. 9” electric wires W18 that has been attached in Step S36 is performed by the moving tape winding mechanism 22. The fixing by wounding the tapes W19 with respect to the exterior material W20 of the “No. 7” and “No. 8” electric wires W18 that has been attached in Step S36 is also performed by the moving tape winding mechanism 22.

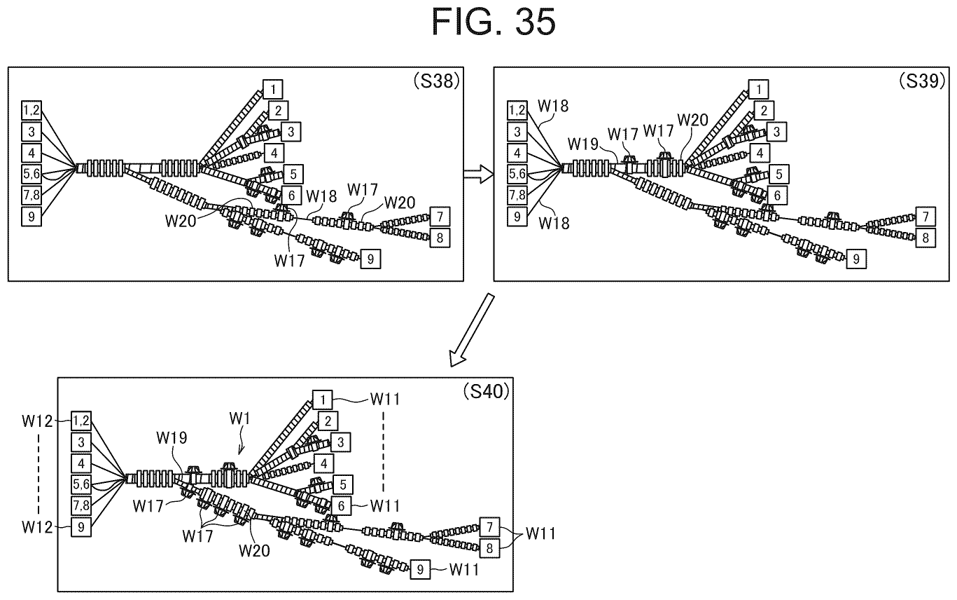

FIG. 35 is a schematic view showing Step S38 to Step S40 of the method for manufacturing wire harness to manufacture the wire harness shown in FIG. 3 by the apparatus for manufacturing wire harness as shown in FIG. 1 and FIG. 2.

In Step S38, regarding the “No. 7” and “No. 8” electric wires W18, one fixing clip W17 is attached on each of the exterior material W20 at two locations. The two fixing clips W17 are attached by the clip attachment portion 23.

In Step S39, regarding the “No. 1” to “No. 6” electric wires W18, two fixing clips W17 are attached by the clip attachment portion 23. One fixing clip W17 is attached on the exterior material W20 near the branch point of the “No. 1” to “No. 6” electric wires W18. The other fixing clip W17 is attached on the tapes W19 wound between this exterior material W20 and the branch point with the “No. 7” to “No. 9” electric wires W18.

In Step S40, regarding the “No. 7” to “No. 9” electric wires W18, four fixing clips W17 are attached thereto by the clip attachment portion 23. Three fixing clips W17 are attached on the exterior material W20 near the branch point of the “No. 7” to “No. 9” electric wires W18. The other fixing clip W17 is attached on the tapes W19 wound between this exterior material W20 and the branch point with the “No. 1” to “No. 6” electric wires W18. By the attachment of the fixing clips W17 in this Step S40, the wire harness W1 shown in FIG. 3 is finished. The finished wire harness W1 is retained by the dispensing portion 26, and all of the 9 tip-end connectors W11 and the 6 rear-end connectors W12 are removed at once from the retaining portions 121 of the sliding portions 12 and the rear-end connector movement portions 163. Then, due to the movement of the dispensing portion 26 by the robot arm 21, the wire harness W1 is transported onto the table as the dispensing destination 26a to be dispensed. As described therebefore, the method for manufacturing wire harness to manufacture the wire harness W1 shown in FIG. 3 by the apparatus for manufacturing wire harness 1 as shown in FIG. 1 and FIG. 2 is finished.

Here, according to the present embodiment, as described before, after the electric wires W18 are pulled out in Step S12, each sliding portion 12 pulls the electric wires W18 in the pulling-out direction D11 to apply the tension thereto. Then, regarding the tension applied in this manner, during the execution of the method for manufacturing wire harness, the apparatus for manufacturing wire harness 1 is controlled by the control portion 27 as follows.

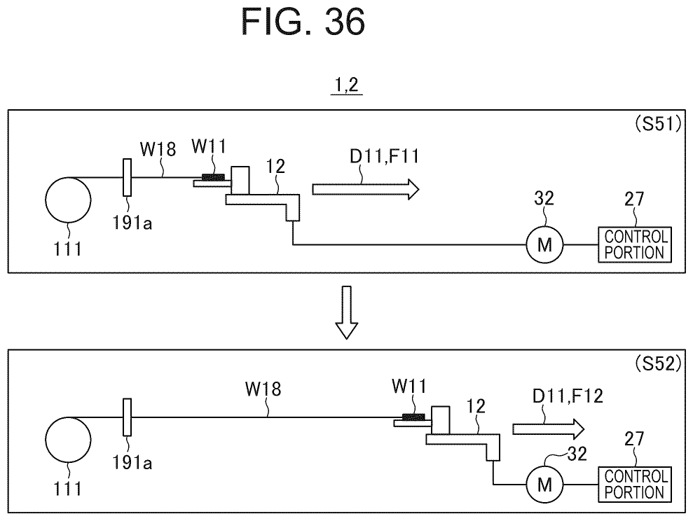

FIG. 36 is a schematic view showing Step S51 and Step S52 of the method for controlling tension of electric wire under the control of the control portion during the execution of the method for manufacturing wire harness as shown in FIG. 28 to FIG. 35.

In FIG. 36, in the apparatus for manufacturing wire harness 1, the component portion functioning as a tension control apparatus 2 configured to control the tension that is applied to the electric wire W18 being pulled from the electric-wire reel 111 during the execution of the method for manufacturing wire harness is shown. The tension control apparatus 2 in the apparatus for manufacturing wire harness 1 includes the sliding portion 12 moving in a straight line by the driving of a servo motor 32 and the control portion 27. The sliding portion 12 is a portion configured to retain the electric-wire end portion of the electric wire W18 that can be pulled out from the electric-wire reel 111 via the tip-end connector W11 and pull out the electric wire W18 by moving in the straight line. The control portion 27 is configured to control the pulling-out amount of the electric wires due to the movement of the sliding portion 12 while performing the following control regarding the tension in the electric wires W18. That is, the control portion 27 obtains the driving force of the servo motor 32 as an indicator showing the tension in the electric wires W18, compares the driving force as the indicator when the sliding portion 12 is stopped with a predetermined reference value, and controls the tension in the electric wires W18 by moving the sliding portion in response to the comparison result.

The Step S51 shown in FIG. 36 is equivalent to the pulling out of the electric wires W18 in Step S12 in FIG. 28. According to this Step S51, the electric wires W18 are pulled out by the sliding portion 12 moving in the pulling-out direction D11 due to the driving of the servo motor 32. At this time, under the control of the control portion 27, the servo motor 32 drives the sliding portion 12 by the following driving force F11. This driving force F11 becomes a necessary force for the sliding portion 12 to pull out the electric wires W18 from the electric-wire reel 111 via the electric-wire grasping mechanism 191a in the ungrasping state. Also, at the time of pulling out this electric wires W18, the control portion 27 control the pulling-out amount of the electric wires by the movement of the sliding portion 12 in the straight line. The pulling-out amount is obtained at the control portion 27 based on the rotation speed of the servo motor 32 or the like. The control portion 27 stops the plurality of sliding portions 12 at the timing when each sliding portion 12 has moved by the movement amount corresponding to the pulling-out amount of the electric wires.

In Step S52, the pulling out of the electric wires W18 is finished and the sliding portions 12 are stopped. In this stopping state, the electric-wire grasping mechanism 191a is in the grasping state and the sliding portion 12 is pulling the electric wires W18 in the pulling-out direction D11 at a balancing force F12 that is balanced with the grasping force by the electric-wire grasping mechanism 191a. Due to the pulling at the balancing force F12 by the sliding portion 12, the predetermined tension is applied to the electric wires W18. According to the present embodiment, the value corresponding to this grasping force of the electric-wire grasping mechanism 191a is used as the reference value.

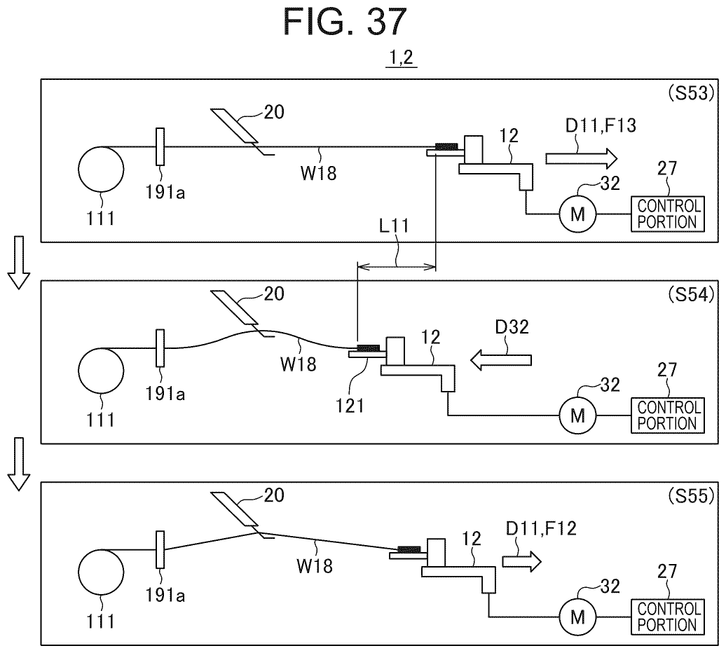

FIG. 37 is a schematic view showing Step S53 to Step S55 of the method for controlling tension of electric wire under the control of the control portion during the execution of the method for manufacturing wire harness as shown in FIG. 28 to FIG. 35.

In this FIG. 37, a situation as an example is shown that in the tension control apparatus 2 of the apparatus for manufacturing wire harness 1, as an example of the situation in which the tension in the electric wires W18 increases when the sliding portion 12 is stopped, the electric wires W18 are pulled since they are gathered by the large-scale portion 20.

In Step S53, when the sliding portion 12 is pulling the electric wires W18 from the electric-wire reel 111 by the balancing force F12 with respect to the grasping force of the electric-wire grasping mechanism 191a, the electric-wire gathering by the large-scale gathering portion 20 is started. According to the present embodiment, this large-scale gathering portion 20, and the small-scale gathering portion 225 in the moving tape winding mechanism 22 similarly performing the electric-wire gathering are bundling portions to bundle the plurality of electric wires W18. Hereinafter, the large-scale gathering portion 20 as this bundling portion will be described as an example.

When the bundling by the large-scale gathering portion 20 is performed, the electric wires W18 are pulled such that the tension is temporarily increased, and in response to this situation, the output from the servo motor 32 driving the sliding portion 12 is temporarily increased to an increasing driving force F13 from the above-described balancing force F12. According to the present embodiment, in the control portion 27, the reference value used for the tension control is set to be less than the temporarily increased driving force of the servo motor 32 due to the bundling by the large-scale gathering portion 20 and the small-scale gathering portion 225. Eventually, when the increasing driving force F13 in the pulling-out direction D11 exceeds the reference value, the process at the control portion 27 transitions to the next Step S54.

In Step S54, the control portion 27 moves the sliding portion 12 in a tension alleviating direction D32 as an opposite direction of the pulling-out direction D11 of the electric wires W18 at an alleviating direction L11 that is longer than the necessary distance to make the driving force of the servo motor 32 is less than the above-described reference value. Furthermore, according to the present embodiment, the control portion 27 rotates the retaining portion 121 in the sliding portion 12 in the rotation direction D14 as shown in FIG. 5 in a tension-alleviating rotation direction in which the indication is decreased. This tension-alleviating rotation direction is a direction to direct the retaining portion toward the bundling point of the electric wires W18. Therefore, the electric wires W18 from the electric-wire reel 111 enter the relaxed state via the large-scale gathering portion 20 between the sliding portion 12 and the electric-wire grasping mechanism 191a. After this movement, the processing transitions to the next Step S55.

Here, in Step S55, as the processing after the above-described movement, the control portion 27 moves the sliding portion 12 in the pulling-out direction D11 to stopping position while pulling the electric wires W18 at the balancing force F12 balanced with the grasping force of the electric-wire grasping mechanism 191a. Thus, the electric wires W18 from the electric-wire reel 111 enter the state of being stretched at a predetermined tension while passing through the large-scale gathering portion 20 between the sliding portion 12 and the electric-wire grasping mechanism 191a. The processing as the tape winding at the bundling by the large-scale gathering portion 20 and the like are performed in such state in which the electric wires W18 are stretched.

Here, according to the present embodiment, there is a case in which the control portion 27 evacuates the sliding portion 12 to a predetermined evacuation position in the above-described tension alleviating direction D32 after the electric wires W18 are pulled out by the movement of the sliding portion 12. Such evacuation is performed so as to avoid the interference with the mechanism apparatus that is carried by the robot arm 21 for performing the processing such as the tape winding with respect to the electric wires W18 that are pulled out by other sliding portion 12.

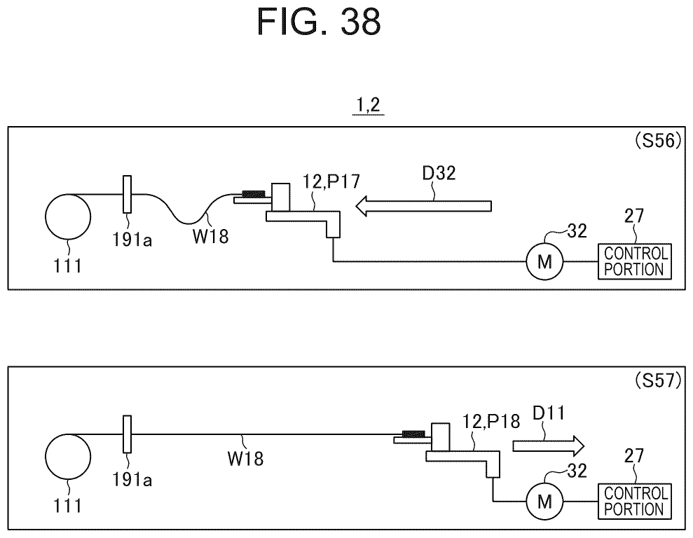

FIG. 38 is a schematic view showing Step S56 and Step S57 of the method for controlling tension of electric wire under the control of the control portion during the execution of the method for manufacturing wire harness as shown in FIG. 28 to FIG. 35.

In this FIG. 37, the evacuation processing of the sliding portion 12 that is performed as one stage of the method for controlling tension by the control portion 27 configuring the tension control apparatus 2 in the apparatus for manufacturing wire harness 1 according to the present embodiment is schematically shown.

According to Step S56 in this evacuation processing, the control portion 27 controls the servo motor 32 to evacuate the sliding portion 12 to a predetermined evacuation position P17 in the above-described tension alleviating direction D32 when the evacuation period arrives when approaching of other mechanical mechanisms are expected. Due to such evacuation, the electric wires W18 from the electric-wire reel 111 enter the significant relaxed state between the sliding portion 12 and the electric-wire grasping mechanism 191a. Then, when the above-described evacuation period is finished, the processing transitions to the next Step S57.

In Step S57, the control portion 27 moves the sliding portion 12 to the pulling-out direction D11 to make the sliding portion 12 return to a balancing position P18 before the evacuation. Due to the returning of the sliding portion 12, the electric wires W18 from the electric-wire reel 111 are in the state of being stretched at the predetermined tension between the sliding portion 12 and the electric-wire grasping mechanism 191a.

According to the present embodiment, the method for controlling tension including this evacuation are performed parallelly under the control of the control portion during the execution of the method for manufacturing wire harness being shown in FIG. 28 to FIG. 35.

According to the apparatus for manufacturing wire harness 1, the method for manufacturing wire harness, the wire harness W1, the tension control apparatus 2, and the method for controlling tension described in the present embodiment, the following effects can be achieved from various aspects.

At first, the apparatus for manufacturing wire harness 1, the method for manufacturing wire harness, and the wire harness W1 according to the present embodiment, the following configuration can be realized and the effects due to such configuration can be achieved from the viewpoints of forming the branch of the electric wires W18 by tape winding.

According to the apparatus for manufacturing wire harness 1 described in the present embodiment, the under-pulling tape winding portion 181 in the fixing tape winding mechanism 18 and the moving tape winding mechanism 22 are functioning as preceding tape winding portions as follows. The preceding tape winding portion is a portion performing the tape winding to the electric wires W18 that are connected to the same tip-end connector W11 among the tip-end connectors W11 and the electric wires W18 prepared in a plural for manufacturing the wire harness W1. Then, the moving tape winding mechanism 22 performing the tape winding with respect to the electric wires W18 as the targets of the electric wire gathering are functioning as following tape winding portions as follows. The following tape winding portion is a portion forming the branch by performing the tape winding with respect to the portions where the tape winding has been individually performed by the preceding tape winding portions in the electric wires W18 connected to different tip-end connectors W11.

In the method for manufacturing wire harness as shown in FIG. 28 to FIG. 35, the processing of Step S12 to Step S16 in which the under-pulling tape winding portion 181 and the moving tape winding mechanism 22 are functioning as the preceding tape winding portions become the preceding tape winding process. The preceding tape winding process is the process of performing the tape winding with respect to the electric wires W18 connected to the same tip-end connector W11. Also, Step S19, Step S26, Step S28, Step S31, and Step S35 in which the moving tape winding mechanism 22 is functioning as the following tape winding portion become the following tape winding process. The following tape winding process is the process in which the portions to which the tape winding has been performed in the electric wires W18 connected to the different tip-end connectors W11.

According to the apparatus for manufacturing wire harness 1 having such configuration and the method for manufacturing wire harness according to the present embodiment, at first, the tape winding is performed in advance with respect to the electric wires W18 connected to the same tip-end connector W11. Thereafter, the tape winding is performed with respect to the electric wires W18 to which the preceding tape winding has been performed and connected to the different tip-end connectors W11. Due to the 2-stage tape winding including the preceding tape winding and the following tape winding, the formation of the branch shape and the shape determination by the tape winding are parallelly performed. These operations can be effectively automated as they can be performed without special skill as long as the preceding and following steps are followed, and the apparatus for manufacturing wire harness according to the present embodiment is the automatic manufacturing apparatus based on this point. In this manner, according to the above apparatus for manufacturing wire harness 1 and the method for manufacturing wire harness, it is possible to automatically perform the operations from the formation of the branch shape to the shape determination by the tape winding.

Here, according to the present embodiment, the moving tape winding mechanism 22 as the following tape winding portion performs overlapping and winding the tapes W19 on the tapes W19 that have been wound by the under-pulling tape winding portion 181 and the moving tape winding mechanism 22 as the preceding tape winding portion. According to such configuration, for example, compare with a situation in which the tape winding is performed by the following tape winding portion while avoiding the tapes W19 that have been wound by the preceding tape winding portion, it is easy for the tape winding performed by the following tape winding portion easy to be performed. In view of the ease of the tape winding by the following tape winding portion, it is possible to make the above-mentioned series of operations automated furthermore effectively.

Also, according to the present embodiment, the sliding portion 12 configured to pull out the electric wires W18 is provided. Then, the preceding tape winding portion includes the under-pulling tape winding portion 181 to perform the tape winding of the electric wires W18 being pulled out and the moving tape winding mechanism 22 functioned as an after-pulling tape winding portion to perform the tape winding of the electric wires W18 that have been pulled out. Also, the following tape winding portion performs the tape winding with respect to the portions to which the tape winding has been performed in the electric wires W18 after been pulled out. According to this configuration, the tape winding by the sliding portion 12 is performed at each timing of being pulled out and after being pulled out such that it is possible to make the operations from the formation of the branch shape to the shape determination by the tape winding automated furthermore effectively. Furthermore, by performing the tape winding at each timing of being pulled out and after being pulled out, it is also possible to shorten the operation time.

Also, according to the present embodiment, the under-pulling tape winding portion 181 performs the tape winding without any movement, and the after-pulling tape winding portion and the following tape winding portion move along the electric wires W18 due to the moving tape winding mechanism 22 to perform the tape winding. According to such configuration, part of the tape winding is the operation without any movement such that it is possible to simplify the mechanism relating to the tape winding.

Also, according to the present embodiment, the after-pulling tape winding portion and the following tape winding portion perform the tape winding while moving from the tip-end side toward the rear-end side along the pulling-out direction D11 of the electric wires W18 due to the moving tape winding mechanism 22. According to such configuration, it is possible to use the tip-end connectors W11 or the like positioned at the tip-end side in the pulling-out direction D11 as the reference of the starting of the tape winding.

Also, according to the present embodiment, the exterior material attachment portion 24 configured to perform the attachment of the exterior material W20 is provided, and the after-pulling tape winding portion and the following tape winding portion due to the moving tape winding mechanism 22 also perform the tape winding for fixing the exterior material W20 to the electric wires W18. According to such configuration, the operations from attaching the exterior material W20 to the fixing can be automatically performed without human intervention at any time.

Also, according to the present embodiment, the robot arm 21 grasps and carries the moving tape winding mechanism 22 to the winding position of the tapes W19 while moving it in response to the tape winding operations so as to make the tape winding mechanism 22 to operate as the after-pulling tape winding portion and the following tape winding portion. According to such configuration, the moving tape winding mechanism 22 is carried by the robot arm 21 to the winding position of the tapes W19 and appropriately operated so as to configure the after-pulling tape winding portion and the following tape winding operation. Therefore, compared with the configuration in which each of the after-pulling portion and the following tape winding portion is mounted as an individual mechanism, it is possible to simplify the apparatus configuration of the apparatus for manufacturing wire harness 1.

Also, according to the present embodiment, at least one sliding portion 12 (in the present embodiment, all of the sliding portions 12) among the plurality of sliding portions 12 rotates the tip-end connector W11 around the twisting axis X12 as the center after pulling out the electric wires W18 to be able to twist the electric wires W18. Then, among the precedent tape winding portions, the after-pulling tape winding portion due to the moving tape winding mechanism 22 performs the tape winding with respect to the twisted electric wires W18 as one of the winding targets. According to such configuration, regarding the wire harness W1 having the twisted electric wires W18, it is possible to automatically perform the operations from the formation of the branch shape to the shape determination by the tape winding.

Also, according to the present embodiment, the under-pulling tape winding portion 181 is provided in a plural to line up in the orthogonal direction D13 with respect to the pulling-out direction D11 of the electric wires W18. Then, each under-pulling tape winding portion 181 rotates the tape reel 181a with each electric wire W18 as the center and wind the tape W19 being pulled out from this tape reel 181a on each electric wire W18. According to such configuration, due to the plurality of under-pulling tape winding portions 181, it is possible to parallelly perform the tape winding simultaneously with respect to the electric wires W18 being pulled out by the plurality of sliding portions 12.

Also, according to the present embodiment, the plurality of under-pulling tape winding portions 181 rotate the tape reel 181a in the same reel rotation direction D28. According to such configuration, the reel rotation directions D28 of the tape reel 181a are the same among the plurality of under-pulling tape winding portions 181 such that it is possible to reduce the gap therebetween the plurality of under-pulling tape winding portions 181 while avoiding the interference therebetween. Then, since the gap therebetween is reduced such that it is possible to avoid the enlargement of the apparatus to arrange the plurality of under-puling tape winding portions 181 one by one.

Also, according to the present embodiment, the clip attachment portion 23 is provided. According to such configuration, it is possible to automatically perform the attachment operation of the fixing clip W17.

Also, the wire harness W1 being manufactured by the apparatus for manufacturing wire harness 1 and the method for manufacturing wire harness according to the present embodiment, the side of each tip-end connector W11 becomes the branch-wire tape-winding portion W13 to form the branch wire. This branch-wire tape-winding portion is a portion where the electric wires W18 connected to the same tip-end connector W11 is wound by tapes. Then, the portion where these branch-wire tape-winding portions W13 are wound by tapes to form the branch becomes the branch tape-winding portion W15.

For the above-described wire harness W1, it is possible to parallelly perform the operations from the formation of the branch shape to the shape determination by the tape winding simultaneously by the two-stage tape winding of performs the tape winding with respect to the branch wire in advance, and then performing the tape winding by bundling these to form the branch. These operations can be effectively automated because they can be performed without special skill as long as the two-step tape winding process is followed. Accordingly, regarding the above-described wire harness W1, it is possible to manufacture the wire harness W1 by automatically performing the operations from the formation of the branch shape to the shape determination by the tape winding.

Next, the apparatus for manufacturing wire harness and the method for manufacturing wire harness according to the present embodiment include the following configurations while achieving the following effects due to such configurations from the viewpoints of regulating the electrics W18 in the parallel state to perform the manufacturing operations.

According to the apparatus for manufacturing wire harness 1 according to the present embodiment, the electric-wire grasping mechanism 191a with the comb-tooth shape and the plurality of sliding portions 12 pulling out the electric wires W18 to apply appropriate tension thereto and pull the electric wires W18 function as the parallel regulation portions. The parallel regulation portions are the portions to regulate the plurality of prepared electric wires in the parallel state. Also, the under-pulling tape winding portion 181 in the fixing tape winding mechanism 18 and the moving tape winding mechanism 22 function as preceding bundling portion configured to select and bundle part of electric wires W18 among the plurality of electric wires W18. Also, the moving tape-winding mechanism 22 functions as the following bundling portion configured to further bundle the bundled portions by the preceding bundling portion to form the branch.

Also, in the method for manufacturing wire harness as shown in FIG. 28 to FIG. 35, from Step S12 in which the electric wires W18 in the parallel state are pulled out until immediately before Step S30 in which the parallel state of all electric wires W18 collapse, that is, the processing until Step S29 is the parallel regulation step. The parallel regulation step is the processing to regulate the plurality of electric wires W18 in the parallel state.

Also, each step from Step S12 to Step S16 in which the under-pulling tape winding portion 181 and moving tape winding mechanism 22 function as the preceding bundling portion is the preceding bundling process in which part of the plurality of electric wires W18 is selected to be bundled. Also, each of Step S19, Step S26, Step S28, Step S31, and Step S35 in which the moving tape winding mechanism 22 functions as the following tape winding portion is the following bundling step. The following bundling step is the step in which the portions have been bundled in the preceding bundling step are further bundled to form the branch.

According to the above-described apparatus for manufacturing wire harness 1 and the method for manufacturing wire harness, the manufacturing of the wire harness W1 can be started from regulating the plurality of electric wires W18 in the parallel state that can be mechanically implemented without any skilled operations such as routing the electric wires W18 in the branch shape or the like. Thereafter, through the two-stage bundling including preceding bundling and following bundling, the processing from the formation of branch shape to the shape determination by the bundling are parallelly and simultaneously performed. Regarding the two-stage bundling, it can be mechanically performed since it can be performed without any special skill as long as the procedure is followed. In this manner, either of the processing from the regulation of the parallel state to the formation of the branch shape and the shape determination via the two-stage bundling can be mechanically performed such that they can be effectively automated. The apparatus for manufacturing wire harness 1 according to the present embodiment is an automated manufacturing apparatus in this aspect. In this manner, according to the apparatus for manufacturing wire harness and method for manufacturing wire harness described above, it is possible to automatically perform the processing from the formation of branch shape to the shape determination by the bundling.

Here, in the present embodiment, the parallel regulation portions by the electric-wire grasping mechanism 191a and the sliding portion 12 regulate the plurality of electric wires W18 in the parallel state in the air. According to such configuration, for example, compared with the configuration in which the plurality of electric wires W18 are placed and fixed on a wiring board or the like, the degree of freedom in accessing the wires W18 during subsequent bundling is increased such that it is possible to optimize the accessing direction for the electric wire W18 thereafter.

Also, in the present embodiment, the parallel regulation portions by the electric-wire grasping mechanism 191a and the sliding portion 12 regulate the plurality of electric wires W18 from both sides by sandwiching the space in the air in the longitudinal direction of the electric wires W18. According to such configuration, for example, compared with the configuration to support the plurality of electric wires W18 at multiple locations in the longitudinal direction and regulate the electric wires W18 in the parallel state or the like, it is possible to further increase the degree of freedom in the access to the electric wires W18 in the bundling.

Also, according to the present embodiment, in the method for manufacturing wire harness, the parallel regulation processing from Step S12 to Step S29 is performed as follows. That is, according to the present embodiment, in this parallel regulation processing is performed in parallel in the preceding bundling processing including Step S12 to Step S16 and the following bundling processing including Step S19, Step S26, and Step S28. According to such configuration, the parallel regulation processing is performed in parallel in both of the preceding bundling processing and the following bundling processing such that it is possible to effectively avoid the situations such as the electric wires become loose and tangled inadvertently unintentionally during the formation of the branch shape and the like.

Next, according to the present embodiment, in the viewpoints that the apparatus for manufacturing wire harness 1 includes the tension control apparatus 2 and the method for manufacturing wire harness includes the tension control method, the following configuration is included while the effects due to such configuration can be achieved.

At first, the tension control apparatus 2 includes the sliding portion 12 retaining the end portion of the electric wire to move in a straight line and the control portion 27. The control portion 27 controls the pulling out amount of the electric wire while acquiring the driving force of the servo motor 32 for driving the sliding portion 12 as the indicator showing the tension of the electric wire W18. Then, the control portion 27 compares the driving force as the indicator when the sliding portion stops with the predetermined reference value and moves the sliding portion 12 in response to the comparison result.

Then, the apparatus for manufacturing wire harness 1 according to the present embodiment includes the above-described tension control apparatus 2 and an operation mechanism configured to perform the manufacturing operations of the wire harness W1 with respect to the electric wires W18 in the state in which the tension is controlled by this tension control apparatus 2. According to the present embodiment, in the apparatus for manufacturing wire harness 1 as shown in FIG. 2, the plurality of configuration elements except for the tension control apparatus 2 shown in FIG. 36 function as the above-described operation mechanism.

Also, according to the tension control method of the present embodiment, in the tension control method as shown in FIG. 36 to FIG. 38, Step S51 becomes the pulling-out amount control processing of controlling the pulling-out amount of electric wires by moving the sliding portion 12 in the straight line. Then, the following Step S52 to Step S57 become the movement control processing of comparing the driving force of the servo motor 32 as the indicator of the tension when the sliding portion stops with the reference value and moving the sliding portion 12 in response to the comparison result.

Then, the method for manufacturing wire harness according to the present embodiment includes the tension control processing (Step S51 to Step S57) to control the tension of electric wires by the above-described tension control method and the operation processing (Step S11 to Step S40) to perform the manufacturing operations of the wire harness.

According to the tension control apparatus 2, the apparatus for manufacturing wire harness 1, the tension control method, and the method for manufacturing wire harness of the present embodiment, the following effects can be achieved. That is, according to the present embodiment, at the time when the sliding portion 12 is stopped after the electric wires W18 are pulled out by the desired pulling out amount of electric wires, the movement of the sliding portion 12 is controlled by the control portion 27 in response to the comparison result of comparing the indicator showing the tension of the electric wire W18 and the predetermined reference value. Due to the movement control of this sliding portion 12, when an excessive tension excessing the reference value is about to be applied to the electric wires W18 when the sliding portion 12 is stopped, it is possible to take measures such as moving the sliding portion in the direction of relieving the tension so as to suppress the tension applied to the electric wires W18. Also, the necessary configurations for such tension control can be the configuration for pulling out the electric wires and the control configuration thereof. In this manner, according to the present embodiment, it is possible to suppress the tension applied to the electric wires by a simple configuration.

Here, according to the present embodiment, the sliding portion 12 is mounted with the tip-end connector W11 to which the end portion of the electric wire is connected to be the configuration moving in the straight line. According to such configuration, in the situation of handling the electric wires W18 with the end portion of electric wire to which the tip-end connector W11 is connected, it is possible to effectively retain the end portion of the electric wire via the tip-end connector W11 with better retention characteristic than the electric wire itself and perform the tension control.

Also, according to the present embodiment, the electric-wire grasping mechanism 191a is provided at the pulling-out root side of the electric wire W18, and the sliding portion 12 pulls out the electric wires W18 when the electric-wire grasping mechanism 191a is in the ungrasping state. Also, the sliding portion 12 stops while applying the tension pulling the electric wires W18 in the pulling-out direction D11 with the force balanced with the grasping force thereof when the electric-wire grasping mechanism 191a is in the grasping state. Then, the control portion 27 uses the value corresponding to the grasping force of the electric-wire grasping mechanism 191a as the reference value. According to such configuration, by pulling the electric wires W18 at the force balanced with the grasping force at the pulling-out root side, it is possible to perform the operations with respect to the electric wires W18 when the sliding portion 12 stops under the good operability with appropriate tension applied to the electric wires W18.

Also, according to the present embodiment, the sliding portions 12 are provided in a plural to parallel move with each other. Then, the large-scale gathering portion 20 and the small-scale gathering portion 225 of the moving tape winding mechanism 22 are provided as the bundling portions to bundle the plurality of electric wires W18 between the sliding portion 12 and the electric-wire grasping mechanism 191a. Then, in the control portion 27, the reference value of the tension control becomes smaller than the indicator that is temporarily increased due to the bundling by the bundling portions. According to such configuration, for example, even if the tension at the time of bundling the plurality of electric wires W18 is temporarily increased, the tension is reflected to the reference value in the tension control in advance such that it is possible to effectively suppress the increase of the tension thereof.

Also, according to the present embodiment, in a case in which the indicator of the tension exceeds the reference value, the control portion 27 moves the sliding portion 12 only for a relaxation distance L11 being longer than a necessary distance for making the indicator to fall below the reference value in a tension relaxation direction D32. Furthermore, after the movement, the control portion 27 moves the sliding portion 12 in the pulling-out direction D11 until the stopping position while pulling the electric wires W18 at a balancing force F12 balanced with the grasping force of the electric-wire grasping mechanism 191a. According to such configuration, in the case in which the indicator exceeds the reference value, at first, the sliding portion 12 is significantly moved only for the above-described long relaxation distance L11 such that the tension in the electric wires W18 is significantly suppressed. Thereafter, by moving the sliding portion 12 to the stopping position while pulling the electric wires W18 at the balancing force F12, the electric wires W18 are stretched at the appropriate tension. In this manner, according to above-described configuration, it is possible to effectively to realize both goals of rapid relaxation when the tension is increasing and ensuring the satisfied operability with respect to the electric wires W18 thereafter.

Also, according to the present embodiment, when the predetermined evacuation period has arrived, the control portion 27 evacuates the sliding portion 12 to the predetermined evacuation position in the tension relaxation direction D32, and when the evacuation period has finished, the control portion 27 makes the sliding portion 12 to return to the position before the evacuation in the pulling-out direction D12. According to such configuration, for example, in a case in which the sliding portion 12 and the electric wires W18 that are stretched by this sliding portions 12 are obstructing the surrounding operations, it is possible to perform the surrounding operations with the good operability by evacuating the sliding portion with the whole electric wires W18.

Also, according to the present embodiment, the sliding portion 12 includes the retaining portion 121 and the sliding main body portion 122. Then, in a case in which the indicator exceeds the reference value, the control portion 27 moves the sliding main body portion 122 in the tension relaxation direction D32 while rotating the retaining portion 121 in the tension relaxation rotation direction in the rotation direction D14 that is shown in FIG. 5. According to such configuration, in the case in which the indicator exceeds the above-described reference value, due to the movement of the sliding main body portion 122 toward the tension relaxation direction D32 and the rotation of the retaining portion 121 in the tension relaxation rotation direction, it is possible to further effectively suppress the tension in the electric wires W18.

Next, according to the present embodiment, in the viewpoints of pulling out the electric wires by the sliding portion 12 to perform the branch formation, the following configurations are included and the effects according to such configurations can be achieved.

The apparatus for manufacturing wire harness 1 according to the present embodiment includes the sliding portion 12 being provided in a plural wherein each is mounted with the tip-end connector W11 to which the electric wire W18 is connected and moves the tip-end connector W11 in a straight line. Also, the moving tape winding mechanism 22 functions as the branch formation portion to selectively bundle the plurality of electric wires W18 being pulled out by the plurality of sliding portions 12 to form the branch. Then, the control portion 207 controls the pulling-out amount of the electric wires and the branching operations.

In the method for manufacturing wire harness as shown in FIG. 28 to FIG. 35, Step S12 becomes the electric-wire pulling-out processing of pulling out the electric wires W18 while controlling the pulling-out amount of each electric wire W18 by making the sliding portions 12 provided in a plural to move in the straight line. Also, the processing from Step S19 when the branching is started until Step S35 when the branch shape is finally determined becomes the branch formation processing of selectively bundling the plurality of electric wires W18 to form the branch.

According to the apparatus for manufacturing wire harness 1 and the method for manufacturing wire harness according to the present embodiment, any skilled operations such as routing the electric wires W18 in the branched shape is not required. Then, due to the movement in the straight line of the plurality of sliding portions 12 wherein each retains the tip-end connector W11 and subsequently the formation of the branch after the movement, the formation of the branch shape and the shape determination by the bundling are performed. The series of operations can be mechanically implemented and taking this point into consideration, the operations are performed under the predetermined control, since they can be performed without skill only if the procedures are followed. That is, according to the above-described apparatus for manufacturing wire harness 1 and the method for manufacturing wire harness, the operations from the formation of the branch shape to the shape determination by the bundling can be automatically performed.

Here, according to the present embodiment, the rear-end connector connection portion 172 configured to cut the electric wires W18 at the pulling-out root side while connecting them to the rear-end connectors W12 are provided, and the control portion 27 controls the connection operations thereof. According to such configuration, the cutting of the electric wires W18 at the pulling-out root side and the connection with the rear-end connectors W12 can be automatically performed under the control of the control portion 27.

Also, according to the present embodiment, the rear-end connector movement portion 163 is provided as described below. The rear-end connector movement portion 163 is mounted with the rear-end connector W12 at the rear-end connector mounting position P15 being shifted from the rear-end connection position P16 in the orthogonal direction D13. Then, the rear-end connector movement portion 163 is the portion moving in the orthogonal direction D13 so as to position the rear-end connector W12 at the rear-end connection position P16 after the mounting of the rear-end connector W12. The control portion 27 also controls the positioning of the rear-end connector W12 to the rear-end connection position P16 due to the movement of this rear-end connector movement portion 163. According to such configuration, regarding the positioning of the rear-end connector W12 to the rear-end connection position P16 at the pulling-out root side of the electric wires W18, it can be automatically performed under the control by the control portion 27.

Also, according to the present embodiment, the tip-end connector connection portion 171 connecting the electric wires W18 to the tip-end connector W11 at the tip-end connection position P14 at the pulling-out root side is provided. The sliding portion 12 is mounted with the tip-end connectors W12 at the tip-end connector mounting position P13 being opposite to the pulling-out root side, and after the mounting, the sliding portion 12 is the portion moving in the straight line to the pulling-out root side so as to position the tip-end connector W11 at the tip-end connection position P14. The control portion 27 controls the connection operations by such tip-end connector connection portion 171 and the positioning of the tip-end connectors W11 to the tip-end connection position P14 due to the movement of the sliding portion 12. According to such configuration, regarding the series of operations from the positioning of the tip-end connectors W11 to the tip-end connection position P14 due to the movement of the sliding portion 12 to the connection of the tip-end connectors W11, they can be automatically performed under the control of the control portion 27.

Also, according to the present embodiment, the tip-end connector mounting portion 15 configured to mount the tip-end connectors W11 to the sliding portion 12 at the tip-end connector connection position P13 is provided. The control portion 27 also controls the mounting operations of the tip-end connectors W11 to the sliding portion 12 by this tip-end connector mounting portion 15. According to such configuration, regarding the mounting of the tip-end connectors W11 to the sliding portion 12 at the tip-end connector mounting position P13, it can be automatically performed under the control of the control portion 27.

Next, according to the present embodiment, in the viewpoints of the whole configurations of the apparatus and method from pulling out the electric wires W18 due to the movement of the sliding portion 12 until connecting the rear-end connectors W12 via the branch formation, the following configurations are included and the effects according to such configurations can be achieved.

The apparatus for manufacturing wire harness 1 according to the present embodiment includes the plurality of sliding portions 12 that can be mounted with the tip-end connectors W11 and the tip-end connector connection portions 171 connecting the electric wire W18 to the tip-end connector W11 of each sliding portion 12. Also, the apparatus for manufacturing wire harness 1 includes the small-scale gathering portion 225 and the large-scale gathering portion 20 functioning as the electric-wire gathering portions and the moving tape-winding mechanism 22 functioning as the tape winding portion. The electric-wire gathering portions are the portions configured to selectively gather the electric wires W18 being pulled out from different sliding portions 12 to form the branch shape, and the tape winding portion is the portion configured to perform tape winding of the gathered electric wires W18 to determine the branch shape due to the electric-wire gathering portions. Also, the apparatus for manufacturing wire harness 1 includes the rear-end connector movement portion 163 and the rear-end connector connection portion 172. The rear-end connector movement portions 163 are provided in a plural wherein each is mounted with the rear-end connector W12, and each moves in the orthogonal direction D13 so as to sort out the electric wires W18 being pulled out by the movement of the sliding portions 12 to each rear-end connector W12. The rear-end connector connection portions 172 are portions cutting the electric wires W18 that are sorted out to each rear-end connector W12 while connecting the electric wires W18 to the rear-end connectors W12.

Also, in the method for manufacturing wire harness according to FIG. 28 to FIG. 35, Step S11 is the preceding connection processing of sorting out and connecting the electric wires W18 that can be pulled out to the plurality of tip-end connectors W11. Also, Step S12 is the electric-wire pulling-out processing of moving the tip-end connectors W11 in the straight line to be parallel to each other so as to pull out the electric wires W18. Also, Step S19 to Step S35 performing the tape winding together with the electric-wire gathering become the tape winding processing of selectively gathering the electric wires W18 being pulled out to form the branch shape and determining the branch shape by the tape winding. Then, Step S25 is the following connection processing of sorting out the electric wires W18 being pulled out to each rear-end connector W12, and cutting the electric wire W18 being sorted to each rear-end connector W12 while connecting the electric wire W18 to the rear-end connector W12.

According to the apparatus for manufacturing wire harness 1 and the method for manufacturing wire harness according to the present embodiment, the wire harness WI is manufactured through the electric-wire connection to the tip-end connector W11, pulling out the electric wires, the branch formation and determination by the electric-wire gathering and tape winding, and the electric-wire connection to the rear-end connector W12. Either of these series of operations does not require the skilled operations such the routing of the electric wires W18 in the branch shape and can be mechanically performed, and thus either operation can be effectively automated. The apparatus for manufacturing wire harness 1 according to the present embodiment is the automatic manufacturing apparatus based on this point. In this manner, according to the above-described apparatus for manufacturing wire harness and the method for manufacturing wire harness, the series of operations relating to the manufacturing of wire harness W1 can be automatically performed.

Here, according to the present embodiment, the sliding portion 12 includes the retaining portion 121 retaining the tip-end connector W12 and the sliding main body portion 122. Then, the retaining portion 121 twists the electric wire W18 by rotating around the twist axis X12 as the center. According to such configuration, it is also possible to automatically manufacture the wire harness W1 including the twisted electric wires W18 without human intervention.

Also, according to the present embodiment, the retaining portion 121 of the sliding portion 12 is attached so as to be rotatable around the rotation axis X11 being orthogonal to the movement direction D12 of the sliding portion 12 as the center. Then, the retaining portion 121 rotates so as to direct the tip-end connectors W11 toward the direction where the gathered electric wires W18 are directed when the electric wires W18 connected to the tip-end connectors W11 are gathered. According to such configuration, when the electric wires W18 are gathered, due to the rotation of the retaining portion 121, it is possible to suppress the tension applied to the electric wires W18 by directing the tip-end connectors W12 toward the direction where the electric wires W18 are directed due to the rotation of the retaining portion 121.

Also, according to the present embodiment, after the connection of the electric wires W18 from one tip-end connector W11 with the rear-end connector W12 and the cutting thereof are finished, there may be a case in which it is necessary to further connect the adjacent electric wire W18 extending the adjacent other tip-end connector W11 to this rear-end connector W12. In this case, the rear-end connector movement portion 163 moves the rear-end connector W12 to the adjacent rear-end connection position P16 where the connection with the adjacent electric wire W18 is possible. Then, the rear-end connector connection portion 172 connects the adjacent electric wire W18 to the rear-end connector W12 at the adjacent rear-end connection position P16 and cuts it. According to this configuration, at the time of sorting the electric wires W18 connected to the plurality of tip-end connectors W11 to one rear-end connector W12, it is possible to effectively perform the sorting by moving the rear-end connector W12 rather than the electric wires W18 whose posture tends to be unstable. Also, the connection of the electric wires W18 to the rear-end connector W12 are divided into several times for each tip-end connector W11 such that it is possible to suppress the load during the connection with respect to the rear-end connector W12 and the surrounding structure.

Also, according to the present embodiment, the electric-wire gathering portions include the large-scale gathering portion 20 and the small-scale gathering portion 225. According to such configuration, it is possible to effectively perform the electric-wire gathering by using the large-scale gathering portion 20 and the small-scale gathering portion 225 depending on the amount of the electric wires.

Also, according to the present embodiment, the existing-electric-wire arrangement portion 25 configured to arrange the existing electric wires W21 to be parallel to the electric wires W18 is provided. According to such configuration, it is possible to additionally provide the existing electric wires W21 that are separately prepared after pulling out the electric wires W18 by the sliding portions 12 so as to increase the degrees of freedom in the manufacturing of the wire harness W1.

Also, according to the present embodiment, the electric-wire grasping mechanism 191a functioning as the additional-length pulling out portion to further pull out the additional length thereof by grasping and twisting the middle portion of at least part of the electric wires W18 is provided. According to such configuration, for example, it is possible to make part of the electric wires W18 to have the appropriate additional length such that it is possible to increase the degrees of freedom in the manufacturing of the wire harness W1.

Also, according to the present embodiment, the moving tape-winding mechanism 22 as the tape winding portion, before pulling out the additional length, temporarily fixes the electric wires W18 as the targets of the additional length pulling out by winding the tapes at the side of the tip-end connector W12 with respect to the middle portion being grasped during the additional length pulling-out. According to such configuration, due to the temporary fixing with respect to the electric wires W18 as the targets of the additional length pulling out, it is possible to effectively prevent the electric wires W18 from being separated apart during the period of pulling out the additional length.

Also, according to the present embodiment, the dispensing portion 26 configured to move the completed wire harness W1 to the predetermined dispensing destination 26a is provided. According to such configuration, it is possible to automatically perform the manufacturing of the wire harness W1 including the dispensing of the completed wire harness W1.

It is noted that the above-described embodiment are merely the representative embodiments of the apparatus for manufacturing wire harness, the method for manufacturing wire harness, the wire harness, the tension control apparatus, and the tension control method. The apparatus for manufacturing wire harness, the method for manufacturing wire harness, the wire harness, the tension control apparatus, and the tension control method are not limited thereto, and it is possible to implement various modification examples thereof.

For example, according to the above-described embodiment, as an example of the wire harness as the manufacturing target, the wire harness W1 being mounted and routed in the automobile vehicle is shown as an example. However, the wire harness is not limited thereto and it may be the wire harness other than those used for being mounted on the vehicle.

Also, according to the above-described embodiment, as an example of the wire harness as the manufacturing target, the wire harness W1 having the branch shape in which 9 tip-end connectors W11 and 6 rear-end connectors W12 are provided and it is branched at 7 locations is shown as an example. However, the wire harness is not limited thereto, and the specific number of the connectors and the number of the branches are not particularly limited as long as it has the branch shape with connectors provided at both sides.

Also, according to the above-described embodiment, as an example of the apparatus for manufacturing wire harness, the apparatus for manufacturing wire harness 1 having 9 rows of sliding portions 12 and the shape and arrangement of other mechanical portions are specifically shown in FIG. 1 and FIG. 2 is shown. However, the apparatus for manufacturing wire harness is not limited thereto, and it may be configured freely set including the number of the sliding portions and the shape and arrangement of each mechanical portion.

### REFERENCE SIGNS LIST

1 apparatus for manufacturing wire harness
2 tension control apparatus
11 electric wire shelf
12 sliding portion
13 rail
14 tip-end connector supply portion
14a tip-end supply mechanism
15 tip-end connector mounting portion
16 rear-end connector supply portion
16a rear-end supply mechanism
16b connector rail
17 connector connection portion
18 fixing tape winding mechanism
19 electric-wire grasping/additional-length applying portion
20 large-scale gathering portion
21 robot arm
22 moving tape winding mechanism
23 clip attachment portion
24 exterior material attachment portion
25 existing-electric-wire arrangement portion
26 dispensing portion
26a dispensing destination
27 control portion
28 metal frame
29 mechanism waiting table
30 electric-wire guiding portion
31 electric-wire cutting lower mold
32 servo motor
111 electric-wire reel
121 retaining portion
122 sliding main body portion
122a sliding connection portion
122b arm portion
123 connection portion
124 conductivity inspection portion
124a inspection pin
141 tip-end stocker
142 connector delivery portion
142a connector mounting surface
143 rotation mechanism
151 connector transporting portion
151a connector hand portion
151b hand up-down mechanism
152, 162a, 201 support bridge
161 rear-end stocker
162 rear-end connector mounting portion
163 rear-end connector movement portion
171 tip-end connector connection portion
171a, 172a crimping portion
172 rear-end connector connection portion
172a electric-wire cutting blade
173, 226 driving source
174 transmission mechanism
181 under-pulling tape winding portion
181a, 223 tape reel
181b retaining arm
182, 192 support rail
191 grasping unit
191a, 591a electric-wire grasping mechanism
202 gathering arm
221 mechanism frame
222, 231, 241, 251, 261 robot arm connection portion
224 reel rotation mechanism
225 small-scale gathering portion
225a roller
225b gathering blade
225b-1 receiving concave portion
232 retaining hook
233 clip feeding mechanism
242 attachment mechanism
252 main body portion
253 connector retaining portion
262 main body frame
262a tip-end frame
262b rear-end frame
262c middle frame
263 tip-end connector retaining portion
263a support axis
264 rear-end connector retaining portion
301 electric-wire guide
591a-1 fixing end portion
591a-2 moving end portion
591a-3 support rod
D11 pulling-out direction
D12 movement direction
D13 orthogonal direction
D14 rotation direction
D15 twisting direction
D16 inspection movement direction
D17 delivery rotation direction
D18 receiving direction
D19 mounting direction
D20 feed-in direction
D21 position alignment direction
D22, D27 crimping direction
D23, D26 descending direction
D24 ascending direction
D25 sliding direction
D28, D34 reel rotation direction
D29 clamping direction
D31 additional-length rotation direction
D32 tension relaxation direction
D33 support-rod rotation direction
D35 electric-wire clamping direction
D36 tape winding direction
D131 positioning direction
D301 opening direction
D302 closing direction
F11 driving force
F12 balancing force
F13 increasing driving force
L11 relaxation distance
P11 catching posture
P12 delivery posture
P13 tip-end connector mounting position
P14 tip-end connection position
P15 rear-end connector mounting position
P16 rear-end connection position
P17 evacuation position
P18 balancing position
W1 wire harness
W11 tip-end connector
W12 rear-end connector
W13 branch-wire tape-winding portion
W14 branch-wire exterior material portion
W15 branch tape-winding portion
W16 branch exterior material portion
W17 fixing clip
W18 electric wire
W19 tape
W20 exterior material
W21 existing electric wire
X11, X13 rotation axis
X12 twisting axis

1. An apparatus for manufacturing wire harness, comprising
a plurality of sliding portions provided between a first end side and a second end side so as to move parallelly with each other in a straight line, the sliding portions being able to be mounted with tip-end connectors respectively;
a tip-end connector connection portion provided at the first end side and configured to connector the electric wires, that are sorted to be provided to each sliding portion and are able to be pulled out from the first end side to the second end side, to the tip-end connector mounted in the sliding portion as a sorting destination;
an electric-wire gathering portion configured to selectively gather the electric wires that are pulled out by movement of different sliding portions to form a branch shape;
a tape winding portion configured to perform tape winding with respect to the gathered electric wires to determine the branch shape;
a plurality of rear-end connector movement portions provided to have rear-end connectors being mounted therein respectively, each rear-end connector movement portion is configured to sort the electric wires being pulled out by the movement of the sliding portions to each rear-end connector by each rear-end connector movement portion moving in an orthogonal direction with respect to the movement direction of the sliding portion at the first end side; and
a rear-end connector connection portion configured to cut the electric wire being sorted to each rear-end connector while connecting the electric wire to the rear-end connector.

2. The apparatus for manufacturing wire harness according to claim 1,
wherein the sliding portion includes a retention portion retaining the tip-end connector and a sliding main body portion in which the retention portion is mounted, and
the retention portion is a configuration to twist the electric wire by rotating around a twist axis along the movement direction of the sliding portion as a center.

3. The apparatus for manufacturing wire harness according to claim 1,
wherein the sliding portion includes a retention portion retaining the tip-end connector and a sliding main body portion in which the retention portion is mounted, and
the retention portion is attached with respect to the sliding main body portion so as to be rotatable around a rotation axis being orthogonal to the movement direction of the sliding portion as a center, and is configured to rotate such that when the electric wires connecting to the tip-end connectors are gathered by the electric-wire gathering portion, the tip-end connectors are directed toward a direction in which the gathered electric wires are toward.

4. The apparatus for manufacturing wire harness according to claim 1,
wherein the rear-end connector movement portion is configured, after the connection with the rear-end connector and cutting of the electric wire connected to one of the tip-end connectors have been finished in the rear-end connector connection portion, to move the rear-end connector to an adjacent rear-end connection position being able to connect with an adjacent electric wire in a case in which it is necessary to further connect the adjacent electric wire extending to another adjacent tip-end connector to the rear-end connector, and
the rear-end connector connection portion connects the adjacent electric wire to the rear-end connector at the adjacent rear-end connection position and then cuts the adjacent electric wire.

5. The apparatus for manufacturing wire harness according to claim 1, wherein the electric-wire gathering portion includes a large-scale gathering portion configured to gather the electric wires with an amount when the amount of the electric wires as targets exceeds a predetermined amount and a small-scale gathering portion configured to gather the electric wires with the amount when the amount of the electric wires are less than the predetermined amount.

6. The apparatus for manufacturing wire harness according to claim 1, further comprising an existing-electric-wire arrangement portion configured to arrange existing electric wires with both ends connected to the connectors respectively to be parallel to the electric wires that are pulled out by the movement of the sliding portions.

7. The apparatus for manufacturing wire harness according to claim 1, further comprising an additional-length applying portion configured to hold a middle portion along the movement direction of the electric wire among part of the electric wires being pulled out by the movement of the sliding portion while twisting the electric wire with an axis being orthogonal to the movement direction as a center so as to pull out an additional length thereof.

8. The apparatus for manufacturing wire harness according to claim 7, wherein the tape winding portion is configured to perform a temporary fixation with respect to the electric wire as a target of the additional length applying by performing the tape winding to a portion at the tip-end connector side than the middle portion before the additional length applying by the additional-length applying portion.

9. The apparatus for manufacturing wire harness according to claim 1, further comprising a dispensing portion configured to retain the electric wires to which the tip-end connector and the rear-end connector are connected and the tape winding has been performed as the completed wire harness, while removing the tip-end connector and the rear-end connector from the sliding portion and the rear-end connector movement portion all at once and moving the wire harness to a predetermined dispensing destination.

10. A method for manufacturing wire harness, comprising:
a preceding connection step of sorting and connecting electric wires that are able to be pulled out to tip-end connectors provided in a plural respectively;
an electric-wire pulling out step of moving the tip-end connectors along a straight line to be parallel to each other to pull out the electric wires;
a tape winding step of selectively gathering the electric wires being pulled out to form a branch shape while determining the branch shape by performing tape winding; and
a following connection step of sorting the electric wires being pulled out to rear-end connectors provided in a plural respectively, then cutting the electric wire being sorted to each rear-end connector while connecting the electric wire to the rear-end connector.
